(19) United States
(12) Patent Application Publication
(10) Pub. No.: US 2017/0174983 A1
(43) Pub. Date: Jun. 22, 2017

(54) COLOR CHANGING MATERIAL

(71) Applicant: SABIC Global Technologies B.V., Bergen op Zoom (NL)

(72) Inventors: Ihab N. Odeh, Sugar Land, TX (US); Meghna N. Markanday, Thuwal (SA); Jurgen Van Peer, Thuwal (SA); John Van Der Wal, Thuwal (SA); Pradeep Nadkarni, Thuwal (SA); Theo Hoeks, Thuwal (SA); Mohamed Ashraf Moideen, Thuwal (SA); Girish Koripelly, Thuwal (SA)

(21) Appl. No.: 15/128,749

(22) PCT Filed: Mar. 25, 2015
(86) PCT No.: PCT/US2015/022416

§ 371 Date: Sep. 23, 2016

Related U.S. Application Data
(60) Provisional application No. 61/969,906, filed on Mar. 25, 2014.
(60) Provisional application No. 61/969,914, filed on Mar. 25, 2014.
(60) Provisional application No. 61/990,531, filed on May 8, 2014.

(51) Int. Cl. C09K 9/02; C08J 5/18; B32B 27/32; C09B 67/20; B32B 27/36; B32B 27/08; C08K 5/00; C09B 67/02

(52) U.S. Cl. CPC C09K 9/02; C08K 5/0041; C08J 5/18; C09B 67/0097; C09B 67/0063; B32B 27/365; B32B 27/08; B32B 27/32; C08J 2323/06; C08J 2369/00; B32B 2307/4026; B32B 2310/0831

(57) ABSTRACT

Disclosed is a photochromic material that includes a first polymeric layer having a photochromic compound that is capable of being activated in response to a stimulus. The first polymeric layer is configured such that the activated photochromic compound becomes inactivated within 10 minutes, preferably within 5 minutes, most preferably within 1 minute, in the absence of said stimulus.

### CROSS REFERENCE TO RELATED APPLICATIONS

This application claims the benefit of U.S. Provisional Application Nos. 61/969,914 and 61/969,906 filed Mar. 25, 2014, and U.S. Provisional Application No. 61/990,531, filed May 8, 2014. The contents of the referenced applications are incorporated into the present application by reference.

### BACKGROUND OF THE INVENTION

A. Field of the Invention

The invention generally concerns photochromic material in which a color change in response to a stimulus (e.g., electromagnetic radiation such as ultraviolet light or visible light) occurs. These materials can be incorporated into a wide array of products and applications in which color change is desired. In some particular aspects, the photochromic material has the ability to allow photochromic dyes that have been activated in response to a given stimulus to shortly switch back to their inactive form in a short period of time (e.g., less than 10 minutes, less than 5 minutes, less than 4, 3, 2, or 1 minutes) when the stimulus has been removed.

B. Description of Related Art

The incorporation of photochromic dyes in thermoplastic and thermoset polymeric resins has largely remained unsuccessful due to the temperatures used to make the resulting films or layers. Further, photochromic dyes need a certain amount of void space to function efficiently—that is, to switch confirmations from an inactive state to an activated state and back. Thermosets and conventional thermoplastic polymers (e.g., polycarbonates), used to make photochromic materials, however, have a limited amount of void space, thereby resulting in very high switch times between inactive/active states and vice versa. Both of these issues have severely limited the use of dyes in materials in which a desired color change at different time scales could be useful (e.g., construction, eyewear, housing, automotive, among others).

The prevalent solution in today's market is the reliance on coating techniques. By way of example, the current coating technology allows for the production of products such as eyewear where the photochromic dye is coated onto the surface of a thermoplastic substrate (e.g., eyewear, tinted glass, etc.) rather than being incorporated into the substrate. However, such coating solutions are susceptible to faster wear and tear and involve relatively complex and expensive processing steps. One attempt to overcome the deficiencies of coating technologies is to impregnate the photochromic dye in the top layer of a molded lens, which can be complex and can sacrifice the strength of the lens. Other attempts to overcome the deficiencies of coating technologies is to add a photochromic dye to a thermoset monomer and cure the thermoset monomer/photochromic dye composition using ultraviolet or thermal curing techniques, which can also affect the viability of the dye.

### SUMMARY OF THE INVENTION

The present invention offers solutions to the aforementioned problems associated with the use of thermoset polymers and/or thermoplastic polymers with photochromic dyes in color-changing materials. The solutions are premised on the development of a color-changing material that can be designed to change colors or color intensities in response to selected stimuli at selected times. That is, the materials of the present invention can be modified or “tuned” to obtain a desired result for a desired application. By way of example only, desired time-periods for the color change to occur, as well as the variety of colors and color intensities that can be produced, can be achieved by: (1) obtaining polymeric matrices having a sufficient amount of void volume to allow photochromic dyes or compounds to quickly revert back to their inactive state (e.g., less than 10, 9, 8, 7, 6, 5, 4, 3, 2, or 1 minutes, or less than 45 or 30 seconds) upon the removal of a given stimulus; (2) combining various photochromic, thermochromic, or electrochromic materials in a single layer or stacking multiple layers (“layer(s)” and “film(s)” can be used interchangeably throughout this specification) onto one another; (3) varying the concentrations/amounts/ratios of photochromic, thermochromic, or electrochromic materials used in the layer(s); (4) varying the thicknesses of the photochromic and non-photochromic layer(s); (5) varying the position or location (e.g., depth within layer or one side of the layer, etc.) of the photochromic, thermochromic, or electrochromic materials; and/or (6) using non-photochromic layer(s) that have resting or set or permanent colors. Non-limiting applications of the color-changing materials of the present invention include the use of the materials on paint, wallpaper, tiles, appliances, tables, automotive industry (e.g., windows, door panels, roof panels, seating surfaces, tires, rims, wheels, paint, etc.), outdoor surfaces (e.g., concrete, bridges, sport courts, flooring, building surfaces, roofs, windows, street signs, etc.), sporting events (e.g., color of playing surfaces, goal posts, helmets, uniforms, equipment, etc.), eyewear (e.g., ophthalmic lenses, reading glasses, sun glasses, goggles, masks, visors, etc.), etc.

One of the solutions offered by the present invention, obtaining a desired or targeted time period in which the photochromic material changes in response to or in the absence of a given stimulus, uses a polymeric layer that is configured such that the activated photochromic compound in the layer becomes inactivated in a fast period of time (e.g., within 10 minutes or within 5 minutes, or within 4, 3, 2, 1, minutes or less, or less than 45 or 30 seconds) in the absence or removal of a given stimulus. Without wishing to be bound by theory, it is believed that the photochromic material obtains its fast-switching back properties due to the conditions used to make the material (e.g., the material can be made at temperatures of 250° C. and below (e.g., “cold-worked” material), which ensures that the photochromic dye does not degrade during processing), and/or the use of polymers or polymer matrices that allow for sufficient space or void volume (e.g., see FIG. 1) for the dye molecule to convert from an activated form to its inactivated form in a quick and efficient manner once a given stimulus has been removed. One non-limiting application of such a quick-switching back photochromic material is its use with traditional eye wear or with other articles of manufacture that utilize thermoset or conventional thermoplastic polymers (e.g., polycarbonates). In particular, it was discovered that when the quick-switching back photochromic material of the present invention is placed in contact with or adhered to thermoset or conventional thermoplastic polymeric layers, the result was a product that has sufficiently optical clarity and impact strength, while also allowing for a quick color transition of the material (e.g., colored to colorless state or colorless to colored state or first color to second color, etc.) in response to/absence of a stimulus such as electromagnetic radiation (e.g., ultraviolet or visible light or sunlight). Advantageously, this approach does not require the aforementioned coating steps or impregnation of dyes in the top layers of a lens matrix—while such steps are not required, they can be used in combination with the photochromic material of the present invention.

Another solution offered by the present invention is the creation of a stack or laminate structure of photochromic material. This provides a material that can change colors in response to various stimuli such that a desired color or color combination can be obtained under a given set of conditions. Notably, the fast-switching back material discussed above and throughout this specification can be used in the stack, but is not required to be used in the stack. Rather, a wide range of polymeric materials can be used for each layer, where the resulting stack or laminate can then be used to produce the aforementioned color effects. Without wishing to be bound by theory, each polymeric layer can be designed to have a given resting color state (e.g., in the absence of a given signal) that can then be individually stimulated (e.g., through electromagnetic radiation, thermal energy, or electroenergy) to change colors via activation of photochromic, thermochromics, or electrochromic compounds present in each layer. In particular aspects, various photochromic compounds can be used in each layer.

In one aspect of the present invention there is disclosed a photochromic material. The material can include a first polymeric layer comprising a photochromic compound that is capable of being activated in response to a stimulus. The first polymeric layer can be configured such that the activated photochromic compound becomes inactivated in a short period of time (e.g., within 10, 9, 8, 7, 6, 5, 4, 3, 2, or 1 minutes or within 45 or 30 seconds in the absence or removal of said stimulus). The first polymeric material can be such that the photochromic dye or compounds added to the polymeric material retains their structural integrity (e.g., the material can be made at temperatures of 250° C. and below (e.g., “cold-worked” material). This is in contrast to other substrates (e.g., certain polycarbonates polymers) that have to be heated to elevated temperatures greater than 250° C. (e.g., “hot-worked”) in order to soften the polymeric material to a point that the photochromic material can be blended with the substrate. Such “hot” worked polymers can compromise the integrity of any added photochromic dyes or compounds. Addition of the photochromic compound at such elevated temperatures can cause the photochromic compound to undergo a structural or chemical change that is detrimental to the photochromic compound (e.g., the photochromic compound can decompose). The first polymeric layer that allows for fast/quick switching of the photochromic compound can include a polyolefin polymer or copolymer or blends thereof. Non-limiting examples of such polymers are disclosed throughout the specification and incorporated into the present section by reference (e.g., polyethylene or polypropylene polymers or copolymers or blends such as low density polyethylene, high density polyethylene, linear low density polyethylene, medium density polyethylene, ultra-high molecular weight polyethylene, polyethylene-polypropylene copolymer or a cyclic olefin copolymer, or any combination thereof. The first layer can have a thickness that suits its particular application. A non-limiting range can be 1 μm to 4 mm, or the thickness can 2, 3, 4, 5, 6, 7, 8, 9, 10, 100, 200, 300, 400, 500, 600, 700, 800, 900 μm thick or 1, 2, or 3 mm thick or any range therein. The thickness of the first polymeric layer can be modified such that the combination of the first and other layers results in a photochromic material having good optical properties (e.g., high light transmission or low haze (e.g., 0.1 to 10 as determined by ASTM D1003). Non-limiting examples of stimuli include thermal or heat stimuli or electromagnetic radiation stimuli (e.g., ultraviolet light, visible light, sunlight, etc.). Thus, the photochromic material of the present invention can quickly change colors in response to or in the absence or removal of a stimulus (e.g., colorless to colored state, first colored state to a second colored state (where the first and second colored states are different colors), or a colored state to a colorless state, etc.). This shift or change in color states can occur within less than 10, 9, 8, 7, 6, 5, 4, 3, 2, or 1 minute, 30 second, 15 second, or faster. In preferred embodiments the color change can occur within less than 120, 90, 60, or 30 seconds upon exposure to or removal or absence of said stimulus. This fast switching back upon removal or absence of the stimulus is unexpected and surprising in contrast to currently available reversible photochromic materials, which switch back in at an average rate greater than 10 minutes. In preferred aspects, the photochromic material is transparent or translucent prior to and after being subjected to a stimulus such as heat or electromagnetic radiation. In some embodiments, the photochromic material changes from being optically clear (i.e., transmission >70%, Clarity >70%, and Haze <4) and/or colorless state to a colored state in response to said stimulus or changes from a first color to a second color in response to said stimulus. Haze, transmission, and clarity values are measured by using the reference standard. ASTM D1003, which an internationally known and accepted standard for measuring such values. Non-limiting examples of first and second colors include red, orange, yellow, green, blue, indigo, violet, grey, brown, and various shades of such colors. The colors can be designed based on the selection of photochromic compounds or dyes that are used in the material of the present invention. When the stimulus is removed or absent (e.g., thermal or electromagnetic radiation) the photochromic material can revert back to its original colored or colorless state within 10, 9, 8, 7, 6, 5, 4, 3, 2, or 1 minute or within 30 or 15 seconds. In particular aspects, the photochromic material is a planar or substantially planar film or sheet that has a thickness ranging from 1 μm to 10 mm or more preferably 1 μm to 4 mm. Non-limiting examples of photochromic compounds or dyes include those identified in the specification, which are incorporated into this section by reference. Such examples include a chromene, a spiroxazine, a spiropyran, a fulgide, a fulgimide, an anil, a perimidinespirocyclohexadienones, a stilbene, a thioindigoid, an azo dye, or a diarylethene, or any combination thereof.

Further, and as explained in detail below, the photochromic material can include additional polymeric or non-polymeric layers attached to or adhered to the first layers. These additional layers can be designed such that a stack of layers are present within the photochromic material. At least 2, 3, 4, 5, 6, 7, 8, or more additional layers can be incorporated into the photochromic material. The additional layers can be attached to either of the free surfaces of the first layer or can be directly stacked on one another. The additional layers can be polymeric layers such as a polycarbonate layer, a polysulphone layer, a cyclic olefin layer, a thermoplastic polyurethane layer, or a thermoplastic polyolefin layer, or any copolymers or blends thereof. Alternatively, or in combination, the additional layers can be non-polymeric layers such as glass or ceramic or metallic layers. In one particular aspect of the invention, the additional substrate is a polymeric compound (e.g., a second polymeric layer). The second polymeric layer can be a “hot-worked” layer. Non-limiting examples of polymers used in the second polymeric layer are polycarbonate polymer or copolymer thereof, a polysulphone polymer or copolymer thereof, a cyclic olefin polymer or copolymer thereof, a polyurethane polymer or copolymer thereof, a thermoplastic polyolefin polymer or copolymer thereof, a polystyrene polymer or copolymer thereof, a poly(methyl)methacrylate polymer or copolymer thereof, or any optically transparent polymer or copolymers thereof, or any polymeric blends thereof. In particular embodiments, both the first and additional layers can include a photochromic compound or dye identified throughout the specification. In particular instances, the second polymeric layer comprises a polycarbonate polymer or copolymer or a blend thereof. Non-limiting examples of such polymers are provided in the specification and incorporated into this section by reference. In one preferred aspect, the polycarbonate polymer is a copolymer such as bisphenol. A-sebacic acid copolymer. The second polymeric layer can have a thickness that suits its particular application. A non-limiting range can be 1 μm to 4 mm, or the thickness can 2, 3, 4, 5, 6, 7, 8, 9, 10, 100, 200, 300, 400, 500, 600, 700, 800, 900 μm thick or 1, 2, or 3 mm thick or any range therein. This set-up allows for the photochromic compound in the first polymeric layer to efficiently and quickly switch or change its structure from its inactivated state to an activated state or from its activated state to an inactivated state in response to or in the absence or removal of a stimulus, respectively. The first polymeric layer can be in contact with the second polymeric layer such as by co-extrusion of said first and second layers or by lamination of said first and second layers. A portion of the surface of one layer can be in contact with a portion of the surface of the other layer. In some instances, up to 50, 40, 30, 20, 10, or 5% of the respective surfaces of each layer are in contact with the other layer. Alternatively, the first and second layers can be adhered to one another with an adhesive (e.g., polyvinyl acetate or polyvinyl butyral).

Also disclosed is a method for making any one of the aforementioned photochromic materials of the present invention. The photochromic material can be made by extruding in an extruder a composition that includes the first polymer with a photochromic compound. Either a co-extrusion method or a lamination method can be used to make the photochromic materials having more than one layer. Notably, each of these methods simplifies the process for making photochromic articles that have good optical properties. By way of example, the co-extrusion process can include (a) extruding in a first extruder a first composition comprising the polymer and a photochromic compound (first polymeric layer), (b) extruding in a second extruder a second composition comprising the polycarbonate polymer or copolymer or a polymeric blend of said polycarbonate polymer or copolymer (second polymeric layer), and (c) introducing the extruded first and second compositions into a die such that the first and second compositions contact one another to form a photochromic material of the present invention. For the lamination process, it can include (a) obtaining a first polymeric film comprising a polymer and a photochromic compound, (b) obtaining a second polymeric film comprising a polycarbonate polymer or copolymer or a polymeric blend of said polycarbonate polymer or copolymer, and (c) pressing the first and second polymeric films together such that the first and second polymeric films adhere to one another. In a preferred embodiment, the second polymeric film is positioned above the first polymeric film (e.g., a polycarbonate film on the surface of a polyethylene film). The pressing step (c) can include using a pressure of 25 to 250 psi for 1 to 5 minutes at a temperature of 100 to 250° C. In particular aspects, an adhesive (e.g., polyvinyl acetate or polyvinyl butyrol) can be disposed between the first and second polymeric films during the lamination process to ensure sufficient adhesion between the layers. Notably, both the co-extrusion and the lamination processes can be performed at temperatures that do not negatively affect the stability or structure of the photochromic dyes present within the photochromic material of the present invention. For instances, both processes can be performed at temperatures of 250° C. and below or 200° C. and below.

In one non-limiting embodiment of the present invention there is disclosed a multi-layered photochromic material that can include a first polymeric layer comprising one or more photochromic compounds, wherein the first polymeric layer comprises a thermoplastic polymer and is capable of changing from color 1 to color 2 upon exposure to a first stimulus, wherein at least one of the one or more photochromic compounds is an organic photochromic compound; and a second layer. Additional layers can also be added such that a stack or laminate structure having 2, 3, 4, 5, 6, 7, 8, 9, 10, or more layers can be formed, wherein one or more of the layers can be designed independent of the other, to be permanently colored, change colors in response of a given stimulus, change colors in response of a given stimulus and then change back quickly to an inactive color in the absence of a given stimulus, or any combination thereof. In the context of the present invention color 1 means a first color and color 2 means a second color. Color change in the context of the present invention includes, but is not limited to, changes from one color (e.g., red) to another color (e.g., blue), changes of intensity (or tints or shades) (e.g., red to a lighter red or red to a darker red), changes from colorless or transparent to a color (e.g., optically clear to red), changes from a color to colorless or transparent (e.g., red to optically clear), changes from an opaque color to a translucent color or to optically clear, changes from a translucent color or optically clear to an opaque color). Still further, color includes translucent and opaque colors. By way of example, the first layer of the photochromic material can be capable of quickly (e.g., less than 10, 9, 8, 7, 6, 5, 4, 3, 2, 1 or less minutes or less than 45 or 30 seconds) changing from color 2 to color 1 upon removal of the first stimulus. The first stimulus can be electromagnetic radiation (e.g., natural sunlight, ultraviolet radiation, visible light, light from a UV lamp, light from an incandescent, fluorescent, halogen, neon, or LED light source, infrared light, etc.). In some aspects, color 1 or 2 is optically clear. In other aspects, color 1 or 2 or both can be red, orange, yellow, green, blue, violet, white, black, or any shade, tint, or intensity therein or any variation or combination thereof (e.g., brown, magenta, purple, etc.). In some aspects, the second layer of the multi-layered photochromic material can be a non-polymeric layer (e.g., glass, a metal, wood, or a ceramic material, or a substrate to support the photochromic material). In other instances, the second layer of the multi-layered photochromic material can be a polymeric layer or a polymeric blend layer (e.g., layers having a polycarbonate polymer or copolymer thereof, a polysulphone polymer or copolymer thereof, a cyclic olefin polymer or copolymers thereof, a polyurethane polymer or copolymer thereof, a polyolefin polymer or copolymer thereof, a polystyrene polymer or copolymer thereof, a poly(methyl)methacrylate polymer or copolymer thereof, or any optically transparent polymer or copolymers thereof, or any polymeric blends thereof.). Non-limiting examples of polyolefins include polyethylene or polypropylene polymers or copolymers or blends such as low density polyethylene, high density polyethylene, linear low density polyethylene, medium density polyethylene, ultra-high molecular weight polyethylene, polyethylene-polypropylene copolymer or a cyclic olefin copolymer, or any combination thereof. The second layer of the photochromic material can include a second photochromic compound or material, thermochromic compounds or materials, or electrochromic compounds or materials, or any combination thereof. This second layer can be capable of changing from color 3 to color 4 upon exposure to the first stimulus or upon exposure to a second stimulus or upon exposure to both stimuli. Color 3 means a third color. Color 4 means a fourth color that is different from the third color. The second stimulus can be electromagnetic radiation, heat, or electric current or any combination thereof. The second layer can be capable of changing color from color 4 to color 3 upon removal of the first or second stimulus or upon removal of both stimuli. Color 3 or 4 can each be optically clear, red, orange, yellow, green, blue, violet, white, black, or any shade or variation or combination thereof. In particular instances, one of color 3 or color 4 can be optically clear. The multi-layered photochromic material can further include a third layer. The third layer can be capable of changing from color 5 to color 6 upon exposure to the first or second stimuli, or upon exposure to a third stimulus. Color 5 means a fifth color. Color 6 means a sixth color that is different from the fifth color. The multi-layered photochromic material can further include a fourth layer. The fourth layer can be capable of changing from color 7 to color 8 upon exposure to the first or second stimuli, or upon exposure to a fourth stimulus. Color 7 means a seventh color. Color 8 means an eight color that is different from the seventh color. In certain non-limiting embodiments, colors 1, 2, 3, 4, 5, 6, 7, and 8, can each be different colors. Third and/or fourth stimulus can be electromagnetic radiation, heat, or electric current or any combination thereof. The third layer can be capable of changing color from color 6 to color 5 upon removal of the first, second, and/or third stimulus. The fourth layer can be capable of changing color from color 8 to color 7 upon removal of the first, second, and/or fourth stimulus. Colors 5, 6, 7, and 8 each can individually be optically clear, red, orange, yellow, green, blue, violet, white, black, or any shade or variation or combination thereof. In some instances, color 5 or 6 is optically clear and one of color 7 or 8 is optically clear. In some embodiments, the first polymeric layer can include a non-photochromic dye or pigment which imparts a first initial color to the first layer in the absence of the first stimulus. The second layer can include a non-photochromic dye or pigment which imparts a second initial color to the second layer in the absence of the second stimulus. The third layer can include a non-photochromic dye or pigment which imparts a third initial color to the third layer in the absence of the third stimulus. The fourth layer can include a non-photochromic dye or pigment which imparts a fourth initial color to the fourth layer in the absence of the fourth stimulus. In some instances, one or more of the layers can include an irreversible photochromic compound that changes to the activated state and not change back the inactivated state upon removal of the stimulus. In some instances only a portion of the layer changes color in response to the stimulus and then quickly changes back to the original color upon removal of the stimulus (e.g., instances where the photochromic compound is placed within a particular portion or position of a given layer, then that portion of the layer can have color changing properties). The first, second, third, and fourth layers can each individually be transparent, translucent, or opaque prior to being subjected to said stimulus/stimuli. In one aspects, the first, second, third, and fourth layer are each individually transparent, translucent, or opaque upon being subjected to said stimulus/stimuli. The multi-layered photochromic material can further include a fifth, sixth, seventh, eighth, ninth, or tenth layer, or even more layers. Additional layers allow for additional variations of the colors and variations in response to external stimuli. These additional layers (3, 4, 5, 6, 7, 8, 9, 10, or more), can each individually be polymeric layers or non-polymeric layers (e.g., glass, metal, ceramics, wood), or substrates (e.g., articles of manufacture such as automotive vehicles or surfaces of automotive vehicles, buildings, windows, flooring walls, ceilings, roofs, fish tanks, solar panels, etc.). The additional layers (3, 4, 5, 6, 7, 8, 9, 10, or more) can each individual include one or more photochromic, thermochromic, or electrochromic compounds or materials or combinations thereof or may not include such photochromic, thermochromic, or electrochromic compounds or materials thereof. In some instances, the multi-layered photochromic material (e.g., the entire surface of the material or just portions of the surface of the material) can be optically clear, red, orange, yellow, green, blue, violet, white, black, or any shade or variation or combination thereof in the absence of the stimulus. In some particular aspects, the multi-layered photochromic material can be optically clear prior to or post activation by a stimulus. Similarly, the multi-layered photochromic material can be optically clear, red, orange, yellow, green, blue, violet, white, black, or any shade or variation or combination thereof upon exposure to the stimulus. The first layer of the color-changing material can be capable of changing from color 1 to color 2 upon exposure to the first stimulus at a rate that is different from the rate at which the second layer can be capable of changing from color 3 to color 4 upon exposure to the second stimulus. The third layer of the color-changing material can be capable of changing from color 5 to color 6 upon exposure to the third stimulus at a rate that is different from the rate at which the first layer is capable of changing from color 1 to color 2 and/or the second layer is capable of changing from color 3 to color 4 upon exposure to the first or second stimulus, respectively. The fourth layer of the photochromic material can be capable of changing from color 7 to color 8 upon exposure to the fourth stimulus at a rate that is different from the rate at which the first layer is capable of changing from color 1 to color 2, the second layer is capable of changing from color 3 to color 4, and/or the third layer is capable of changing from color 5 to color 6 upon exposure to the first, second, or third stimulus, respectively. The rate change of colors in the first, second, third, or fourth layers can be modified by modifying the thickness of each layer or by modifying the amount of a photochromic dye or pigment in each layer or both. Non-limiting examples of the thicknesses of each layer can be 1 μm to 4 mm, or the thickness can 2, 3, 4, 5, 6, 7, 8, 9, 10, 100, 200, 300, 400, 500, 600, 700, 800, 900 μm thick or 1, 2, or 3 mm thick or any range therein. The first layer of the multi-layered photochromic material can be in contact with or adhered to the second layer. In other aspects, however, the first layer is not in contact with or adhered to the second layer. The thermoplastic polymer in the first layer of the photochromic material of the present invention can be a polyolefin polymer or copolymer thereof, a polystyrene polymer or copolymer thereof, a poly(methyl)methacrylate polymer or copolymer thereof, or a polycarbonate polymer or copolymer thereof, or any blends thereof. The second, third, or fourth layers each can include a polycarbonate polymer or copolymer thereof, a polysulphone polymer or copolymer thereof, a cyclic olefin polymer or copolymer thereof, a polyolefin polymer or copolymer thereof, a polystyrene polymer or copolymer thereof, or a poly(methyl)methacrylate polymer or copolymer thereof, or any blends thereof. In particular aspects, the thermoplastic polyolefin polymer or copolymer thereof is polyethylene or polypropylene or a combination thereof. The polyolefin polymer can be a low density polyethylene, high density polyethylene, linear low density polyethylene, medium density polyethylene, or ultra-high molecular weight polyethylene, or any combination thereof. In more particular embodiments, the polyolefin copolymer is a polyethylene-polypropylene copolymer or a cyclic olefin copolymer. The thickness of the first layer of the color-changing material can have a thickness that is different from the thickness of second layer, the third layer, and/or the fourth layer.

Still further, single or multi-layered photochromic material can further include an additive. Non-limiting examples of additives include any one of or any combination of a plasticizer, an ultraviolet absorbing compound, an optical brightener, an ultraviolet stabilizing agent, a heat stabilizer, a diffuser, a mold releasing agent, an antioxidant, an antifogging agent, a clarifier, a nucleating agent, a phosphite or a phosphonite or both, a light stabilizer, a singlet oxygen quencher, a processing aid, an antistatic agent, or a filler or a reinforcing material. Non-limiting examples of ultraviolet absorbing compounds include those that are capable of absorbing ultraviolet. A light comprising a wavelength of 315 to 400 nm (e.g., avobenzone (Parsol® 1789, AbcamBiochemicals®, USA), bisdisulizole disodium (Neo Heliopan® AP, Symrise, Germany), diethylamino hydroxybenzoyl hexyl benzoate (Uvinul® A Plus, BASF), ecamsule (Mexoryl. SX, L′Oreal, France), or methyl anthranilate, or any combination thereof) or those that are capable of absorbing ultraviolet B light comprising a wavelength of 280 to 315 nm (e.g., 4-aminobenzoic acid (PABA), cinoxate, ethylhexyl triazone (Uvinul® T 150, BASF), homosalate, 4-methylbenzylidene camphor (Parsol® 5000), octyl methoxycinnamate (octinoxate), octyl salicylate (octisalate), padimate O (Escalol® 507, Ashland Inc., USA), phenylbenzimidazole sulfonic acid (ensulizole), polysilicone-15 (Parsol® SLX), trolamine salicylate, or any combination thereof), or those that are capable of absorbing ultraviolet A and B light comprising a wavelength of 280 to 400 nm (e.g., bemotrizinol (Tinosorb S, BASF), benzophenones 1 through 12, dioxybenzone, drometrizole trisiloxane (Mexoryl XL), iscotrizinol (Uvasorb® HEB, 3V Sigma, Italy), octocrylene, oxybenzone (Eusolex 4360, Merck KGaA, Germany), or sulisobenzone, or any combination thereof).

Non-limiting examples of pigments that can be used in any of the layers of the photochromic materials of the present invention include metal-based pigments (e.g., cadmium pigments (e.g., cadmium yellow, cadmium red, cadmium green, cadmium orange, cadmium sulfoselenide), chromium pigments (e.g., chrome yellow and chrome green), cobalt pigments (e.g., cobalt violet, cobalt blue, cerulean blue, aureolin (cobalt yellow)), copper pigments (e.g., azurite, Han purple, Han blue, Egyptian blue, Malachite, Paris green, Phthalocyanine Blue BN, Phthalocyanine Green G, verdigris, viridian), iron oxide pigments (e.g., sanguine, caput mortuum, oxide red, red ochre, Venetian red, Prussian blue), lead pigments (e.g., lead white, cremnitz white, Naples yellow, red lead), manganese pigments (e.g., manganese violet), mercury pigments (e.g., vermilion), titanium pigments (e.g., titanium yellow, titanium beige, titanium white, titanium black), and (zinc pigments (e.g., zinc white, zinc ferrite)), or any combinations thereof. Non-limiting examples of other pigments include carbon pigments (e.g., carbon black, ivory black), clay earth pigments or iron oxides (e.g., yellow ochre, raw sienna, burnt sienna, raw umber, burnt umber), and ultramarine pigments (e.g., ultramarine or ultramarine green shade). In some embodiments of the present invention, optically clear can refer to a transmission value of >70%, a clarity value of >70%, and a haze vale of <4) as measured by using the reference standard ASTM D1003, which an internationally known and accepted standard for measuring such values. Other organic dyes that can be used in any of the layers of the photochromic materials of the present invention include photochromic dyes that do not change back when a stimulus is removed (“irreversible photochromic dyes”) and non-photochromic dyes. Non-limiting examples, of non-photochromic dye compounds include pyrophthalones, perylenes, perylene derivatives, or any combination thereof.

In still another embodiment there is disclosed a method of obtaining or varying a selected color or color intensity, in response to a stimulus or stimuli, for any one of the photochromic materials of the present invention. The method can include any one of or any combination of or all of the following steps:
(1) including a responsive material in the photochromic material, wherein the organic photochromic compound changes from color 1 to color 2 upon exposure to the first stimulus and the responsive material changes from color 3 to color 4 in response to a second stimulus, wherein the combination of color 2 and color 4 produces the selected color or color intensity in response to the first and second stimuli;
(2) modifying the thickness of the first polymeric layer or applying an outermost layer to the photochromic material, wherein the selected color or color intensity is obtained in response to the first stimulus;
(3) selectively positioning the organic photochromic compound within the first polymeric layer, wherein the selected color or color intensity is obtained in response to the first stimulus;
(4) obtaining the first polymeric layer having a color 9 in the absence of the first stimulus, wherein the organic photochromic compound changes from color 1 to color 2 upon exposure to the first stimulus and wherein the combination of color 2 and color 9 produces the selected color or color intensity in response to the first stimulus;
(5) including a second layer in the photochromic material that has a color 10 in the absence of the first stimulus, wherein the organic photochromic compound changes from color 1 to color 2 upon exposure to the first stimulus and wherein the combination of color 2 and color 10 produces the selected color or color intensity in response to the first stimulus; or
(6) modifying the amount, by weight, of the organic photochromic compound present in the photochromic material produces the selected color or color intensity in response to the first stimulus.
   In particular aspects, step (1) is used and the responsive material is comprised within the first polymeric layer along with the organic photochromic compound. Alternatively, or additional, the responsive material can also be comprised in a second layer of the photochromic material. As discussed elsewhere, the responsive material can be a second organic photochromic compound, a thermochromic material, or an electrochromic material or any combination thereof or materials and compounds can be used in a single color-changing material. In one embodiment step (2) is used and increasing the thickness of the first polymeric layer or applying an outermost layer to the photochromic material decreases the selected color intensity that is obtained in response to the first stimulus. Alternatively, decreasing the thickness of the first polymeric layer increases the selected color intensity that is obtained in response to the first stimulus. In another aspect, step (3) is used and positioning the organic photochromic compound further away from the first stimulus decreases the selected color intensity that is obtained in response to the first stimulus. Alternatively, positioning the organic photochromic compound closer to the first stimulus increases the selected color intensity that is obtained in response to the first stimulus. In another aspect, step (4) is used, and color 9 can be obtained by using a pigment or a polymer having color 9 (e.g., the first polymeric layer can have a resting or initial non-stimulated color of color 9). In another embodiment, step (5) is used and color 10 can be obtained by using a pigment or a polymer having color 10 (e.g., the second layer can have a resting or initial non-stimulated color of color 10). In another embodiment, step (6) is used and increasing the amount, by weight, of the organic photochromic compound present in the photochromic material can increase the selected color intensity that is obtained in response to the first stimulus. Alternatively, decreasing the amount, by weight, of the organic photochromic compound present in the photochromic material can decrease the selected color intensity that is obtained in response to the first stimulus.

In yet another embodiment there is disclosed a method of obtaining or varying a selected time-period in which any one of the photochromic materials of the present invention changes color or color intensity in response to a stimulus or stimuli. The method can include any one of or any combination of or all of the following steps:
(1) modifying the thickness of the first polymeric layer or applying an outermost layer to the photochromic material to obtain the selected time-period in which the change of color or color intensity occurs in response to the first stimulus;
(2) selectively positioning the organic photochromic compound within the first polymeric layer to obtain the selected time-period in which the change of color or color intensity occurs in response to the first stimulus;
(3) modifying the amount, by weight, of the organic photochromic compound present in the photochromic material to obtain the selected time-period in which the change of color or color intensity occurs in response to the first stimulus; or
(4) including a responsive material in the photochromic material and modifying the amount, by weight, of the responsive material present in the photochromic material to obtain the selected time-period in which the change of color or color intensity occurs in response to the first stimulus or in response to a second stimulus that changes the color of the responsive material from color 3 to color 4.
   In particular aspects, step (1) is used and increasing the thickness of the first polymeric layer or applying an outermost layer to the photochromic material can increase the selected time-period in which the change of color or color intensity occurs in response to the first stimulus. Alternatively, decreasing the thickness of the first polymeric layer can decrease the selected time-period in which the change of color or color intensity occurs in response to the first stimulus. In one embodiment, step (2) can be used and positioning the organic photochromic compound further away from the first stimulus can increase the selected time-period in which the change of color or color intensity occurs in response to the first stimulus. Alternatively, positioning the organic photochromic compound closer to the first stimulus decreases the selected time-period in which the change of color or color intensity occurs in response to the first stimulus. In another aspect, step (3) is used and increasing the amount, by weight, of the organic photochromic compound present in the photochromic material can decrease the selected time-period in which the change of color or color intensity occurs in response to the first stimulus. Alternatively, decreasing the amount, by weight, of the organic photochromic compound present in the photochromic material can increase the selected time-period in which the change of color or color intensity occurs in response to the first stimulus. In a further aspect, step (4) is used and increasing the amount, by weight, of the responsive material present in the photochromic material can decrease the selected time-period in which the change of color or color intensity occurs in response to the first stimulus. Alternatively, decreasing the amount, by weight, of the responsive material present in the photochromic material can increase the selected time-period in which the change of color or color intensity occurs in response to the first stimulus. Again, the responsive material can be a second organic photochromic compound, a thermochromic material, or an electrochromic material or any combination thereof or materials and compounds can be used in a single color-changing material.

Also disclosed is a method for making any one of the multi-layered photochromic materials of the present invention. Either a co-extrusion method or a lamination method can be used. Notably, each of these methods simplifies the process for making the materials of the present invention. By way of example, the co-extrusion process can include (a) extruding a first composition comprising a first thermoplastic polymer or blend thereof and one or more photochromic compounds to obtain the first layer; and (b) attaching or adhering the first layer to the second layer to form the multi-layered photochromic material of the present invention. The second layer can be obtained from extruding a second composition comprising a second polymer or polymer blend to obtain the second layer. The method can further include extruding the first and second compositions into a die such that the first and second compositions contact one another to form the multi-layered photochromic material of the present invention. For the lamination process, it can include (a) obtaining a first polymeric film or layer comprising a thermoplastic polymer and a photochromic compound, (b) obtaining a second film or layer (either polymeric or non-polymeric), and (c) pressing the first and second films or layers together such that the first and second layers adhere to one another. The pressing step (c) can include using a pressure of 25 to 250 psi for 1 to 5 minutes at a temperature of 100 to 250° C. In particular aspects, an adhesive (e.g., polyvinyl acetate or polyvinyl butyrol) can be disposed between the first and second films or layers during the lamination process to ensure sufficient adhesion between the layers. Notably, both the co-extrusion and the lamination processes can be performed at temperatures that do not negatively affect the stability or structure of the photochromic dyes present within the photochromic materials of the present invention. For instances, both processes can be performed at temperatures of 250° C. and below or 200° C. and below. The methods can further comprise subjecting the photochromic material to a stimulus comprising electromagnetic radiation, heat, or an electric current, or any combination thereof, such that the material changes to a desired or targeted color based on the combination of layers or materials used in the layers of the photochromic material of the present invention.

The photochromic material described above and throughout the specification can be coupleable to an article of manufacture. Non-limiting examples of articles of manufacture include windows, glass, eyewear, automobiles or any surface of the automobile (e.g., seats, roof door panels, hood, rims or wheels, dash board), an interior or exterior wall of a house, office building, store, etc., roofs, appliances, table tops, floor or flooring (e.g., tile, wood, linoleum, etc.), tiles, hand-held devices, housing/frame for general products and appliances, fabric and wearables, packaging, containers, circuit boards and electrical/electronic packaging, toys, mass transportation interior and exterior, art and logos, signage, displays, or counterfeit measures.

“Activated photochromic compound” refers to a photochromic compound or dye that changes its structure or form in response to light, thereby resulting in a shift in color of the compound from its original or “inactivated” state to its “activated” state. Non-limiting examples of a structure or shape change include cis-trans isomerization, intramolecular hydrogen transfer, intramolecular group transfers, dissociation processes, and electron transfers.

“Irreversible photochromic compound or dye” refers to compounds or dyes that after being active cannot or are sufficiently slow (e.g., greater than 10 minutes) to switch back to their inactivated state.

Haze, transmission, and optical clarity values are measured by using the reference standard ASTM D1003, which an internationally known and accepted standard for measuring such values.

The term “polymer” refers to homopolymers, copolymers, blends of homopolymers, blends of copolymers, and blends of homopolymers and copolymers.

The term “coupled” is defined as connected, although not necessarily directly, and not necessarily mechanically; two items that are “coupled” may be unitary with each other.

The term “about” or “approximately” are defined as being close to as understood by one of ordinary skill in the art, and in one non-limiting embodiment the terms are defined to be within 10%, preferably within 5%, more preferably within 1%, and most preferably within 0.5%.

The use of the word “a” or “an” when used in conjunction with the term “comprising” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The photochromic material and related processes of making and using said materials of the present invention can “comprise,” “consist essentially of” or “consist of” particular ingredients, components, compounds, compositions, processing steps etc. disclosed throughout the specification. With respect to the transitional phase “consisting essentially of,” in one non-limiting aspect, a basic and novel characteristic of the aforesaid photochromic materials is they can include a single or multiple dyes in one layer having color changing capabilities in response to external stimuli. Still further, at least one of the layers can be structured such that it has fast-switching back properties (e.g., dye that has been activated in response to a given stimulus can switch back to its inactivated state in the absence of said stimulus within 10, 9, 8, 7, 6, 5, 4, 3, 2, or 1 minutes or less than 45 or 30 seconds). Still further, and instances where multiple dyes are used, one of the dyes can be an irreversible photochromic dye.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description.

### BRIEF DESCRIPTION OF THE DRAWINGS

FIG. 1 is an illustration of a polymeric matrix that includes free-volume or space for a photochromic compound or dye to change its shape from an inactivated form to an activated form in response to light such as ultraviolet light.

FIG. 2 is an illustration of various applications for the multi-layered photochromic material of the present invention.

FIG. 3 are thermochromic polymers that can be used with the multi-layered photochromic material of the present invention.

FIG. 4 is an illustration of a process for making a PC-PE laminate structure resulting in an optically clear fused PC-PE film.

FIG. 5 is an illustration of a color wheel.

FIG. 6A is a cross-sectional views of a bi-layer photochromic material of the present invention.

FIG. 6B is a cross-sectional views of a bi-layer photochromic material with a substrate.

FIG. 6C is a cross-sectional views of a bi-layer photochromic material of the present invention with adhesive.

FIG. 6D is a cross-sectional views of a bi-layer photochromic material of the present invention with adhesive and substrate.

FIG. 6E is a cross-sectional views of a multilayer photochromic material of the present invention which may include a protective layer as well.

FIG. 7 is a schematic of a design of a polycarbonate-polyethylene (PC-PE) laminate with more layers of different polymers for additional properties.

FIG. 8 is an illustration of a tri-layered photochromic material of the present invention.

FIG. 9 is an illustration of a bi-layered photochromic material of the present invention.

FIG. 10 is an illustration of a bi-layered photochromic material of the present invention that includes an electrochromic layer.

FIG. 11 is an illustration of a mono-layered photochromic material of the present invention.

FIG. 12A is a graph of wavelength in nanometers versus percent transmittance of a material of the present invention that includes a high flow ductile (HFD) polycarbonate polymer and 500 ppm of dye-2197.

FIG. 12B is a graph of wavelength in nanometers versus percent transmittance of a material of the present invention that includes a HFD polycarbonate polymer and 500 ppm of Storm Purple.

FIG. 12C is a graph of wavelength in nanometers versus percent transmittance of a material of the present invention that includes a HFD polycarbonate polymer and 500 ppm of Sea Green.

FIG. 12D is a graph of wavelength in nanometers versus percent transmittance of a material of the present invention that includes a HFD polycarbonate polymer and 500 ppm of dye 2039.

FIG. 13A are images of a HFD film with spiroxazine dye and a commercial polyurethane coating after UV exposure

FIG. 13B is the HFD film with spiroxazine dye and the commercial polyurethane coating after 10-20 seconds.

FIG. 14A is an image of extruded high density polyethylene polymer (HDPE) with Sea Green dye after exposure to room light.

FIG. 14B is an image of extruded high density polyethylene polymer (HDPE) with Sea Green dye before exposure to room light.

FIG. 15A is a graph of wavelength in nanometers versus percent transmittance of a material of the present invention that includes a HDPE polymer and 1500 ppm of Sea Green dye.

FIG. 15B is a graph of wavelength in nanometers versus percent transmittance of a material of the present invention that includes a HDPE polymer and 500 ppm of Sea Green dye.

FIG. 15C is a graph of wavelength in nanometers versus percent transmittance of a material of the present invention that includes a HDPE polymer and 250 ppm of Sea Green dye.

FIG. 15D is a graph of wavelength in nanometers versus percent transmittance of a material of the present invention that includes a HDPE polymer and 125 ppm of Sea Green dye.

FIG. 16A is a graph of wavelength in nanometers versus percent transmittance of a commercial lens.

FIG. 16B is a graph of wavelength in nanometers versus percent transmittance of a commercial polyurethane coating.

FIG. 16C a graph of wavelength in nanometers versus percent transmittance of a material of the present invention that includes a HDPE polymer and 1500 ppm of Sea Green dye.

FIG. 16D a graph of wavelength in nanometers versus percent transmittance of a material of the present invention that includes a polycarbonate/polyethylene (HFD/HDPE) laminate and 1500 ppm of Sea Green dye.

### DETAILED DESCRIPTION OF THE INVENTION

While previous attempts have been made to produce photochromic materials in response to external stimuli, the materials either (1) lacked sufficient response or switch times to change colors in response to or in the absence of a given stimulus or (2) were limited in the types of colors and stimuli that could be produced under given conditions.

As discussed above, the photochromic materials of the present invention offer solutions to these problems. One solution is a photochromic material that can be configured to rapidly change colors from a first color to a second color in response to the stimulus and then back to the first once the stimulus is removed. In particular aspects, the material can have fast-switching back properties (e.g., dye that has been activated in response to a given stimulus can switch back to its inactivated state in the absence of said stimulus within 10 minutes, preferably within 5 minutes, and more preferably within 4, 3, 2, 1, or less minutes). By way of example, a photochromic material can be structured to include a thermoplastic polymeric-based layer having at least one photochromic compound dispersed or solubilized throughout the matrix or positioned in a targeted area or areas of the matrix. This allows for the layer to change colors from color 1 to color 2 in response to a given stimulus (e.g., electromagnetic radiation) and back in the absence of said stimulus in a responsive or short time period, with the switch back occurring within 10, 9, 8, 7, 6, 5, 4, 3, 2, 1, or less minutes. Another advantage of the invention is that by incorporating the fast-switching back layers (e.g., a skin layer) into a multilayer material (e.g., a lens) the desired effect of changing color in response to the stimulus and rapidly switching back when the stimulus is removed is achieved without the cost and inefficiencies associated with impregnating a polymer matrix such as polycarbonate lenses with a dye.

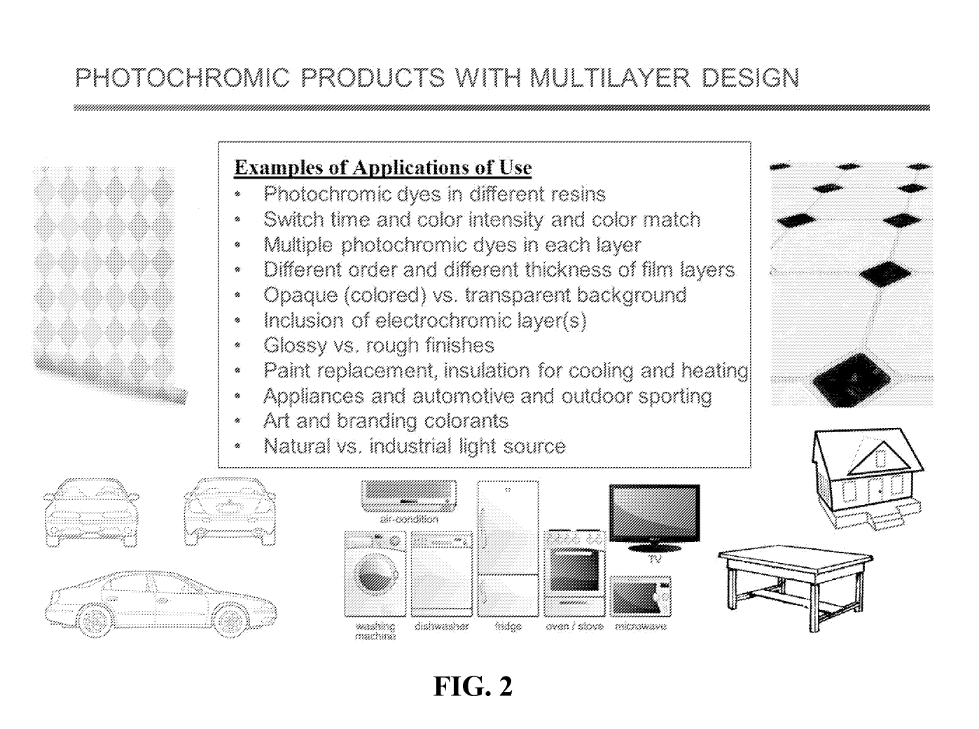

Another solution is the creation of a multi-layer material having individual photochromic layers that can change colors in response to given stimuli and quickly switches back when the stimuli are removed. In some embodiments, at least one of the layers does not change color in response to a given stimuli. In either instance, both solutions can be incorporated into a wide array of products, articles of manufacture, and applications in which color change is desired. By way of another example, a bi-layered material (or 3, 4, 5, 6, 7, 8, 9, 10, or more layers) can be structured such that one of the layers of the present invention includes a thermoplastic polymeric-based layer having at least one photochromic compound dispersed or solubilized throughout the matrix. This allows for the first layer to change colors from color 1 to color 2 in response to a given stimulus (e.g., electromagnetic radiation). The second layer of the present invention can be designed such that it changes colors (e.g., color 3 to color 4) in response to another stimulus (e.g., heat or electrical stimulus). Such a set-up could allow for a change in color from color 1 (e.g., optically clear) to color 2 (e.g., green) in response to sunlight. The second layer can have an initial non-stimulated color (i.e., color 3—e.g., optically clear) that shifts to color 4 (e.g., red) in response to a certain heat level (e.g., greater than 30° C.). Thus, this non-limiting multi-layered material could change colors from optically clear to green in response to sunlight. Then, if the material is further subjected to a temperature of at least 30° C., the second layer could change its color from optically clear to red, thereby causing a color shift in the multi-layered material from green to yellow (red+green=yellow). If sunlight is removed but the heat stimulus remains, then the material could shift its color from yellow to red. Reducing the temperature of the material to less than 30° C. could cause the material to revert back to being optically clear. This type of multi-layered material could be applied to, for example, a white surface (e.g., a wall that is painted white). Thus, the wall would have a white appearance in the absence of sunlight at a room temperature of less than 30° C. If sunlight were to hit the wall, then the color of the wall would appear to shift from white to green. If the temperature of the room rises to at least 30° C., then the wall would appear to shift from green to yellow. If sunlight is removed from the wall (e.g., at night) but the temperature of the room is at least 30° C., then the wall would appear to have a red color. If the temperature of the room goes below 30° C., then the wall would again appear white. FIG. 2 provides a non-limiting illustration of the various set-ups and applications for use of the multi-layered color changing materials of the present invention.

These and other non-limiting aspects of the present invention are discussed in detail in the following sections.

### A. Fast-Switching Back Color Changing Layers

In one instance of the present invention, there is disclosed a color changing material that can include a polymer or polymer blend (e.g., first polymer layer, film, and/or laminate) that is workable at a temperature that allows retention of the structural integrity of a photochromic dye and that also produces a polymeric matrix or layer having more free volume. While it was expected that photochromic dyes would switch quickly to an active state (e.g., colored state), it was unexpected and surprisingly found that the resulting film or layer had the ability to allow the activated dyes to switch back to their respective inactivated forms quickly (i.e., the film or layer had has fast-switching back properties such that a dye having been activated in response to a given stimulus switched back to its inactivated state in the absence of said stimulus within 10 minutes, preferably within 5 minutes, and more preferably within 4, 3, 2, 1, or less minutes). By comparison, conventional materials having such dyes (e.g., polycarbonate lenses having dyes impregnated into the top surface) switch back to their inactive form in the absence of a given stimulus in longer periods of time (i.e., greater than 10 minutes after a stimulus has been removed).

Polymers that are used to create such a polymeric layers or films include polyolefins (e.g., polypropylene, polyethylene, ethylene-propylene copolymers, propylene-butene copolymers, ethylene-propylene-butylene terpolymers, or blends thereof). Non-limiting examples include crystalline polypropylene, crystalline propylene-ethylene block or random copolymer, low density polyethylene, high density polyethylene, linear low density polyethylene, ultra-high molecular weight polyethylene, ethylene-propylene random copolymer, ethylene-propylene-diene copolymer, and the like. In particular aspects, the polyolefin can be modified with at least one functional group selected from a carboxyl, an acid anhydride, an epoxy groups or mixtures containing at least one of the foregoing functional groups. Polyolefins are commercially available from a wide range of sources, one of which is SABIC, which offers a variety of HDPE, LDPE, LLDPE, PP polymers, co-polymers, and blends thereof in a variety of grades, all of which are incorporated in the present application by reference. Polyolefins can be produced by Ziegler-Nana catalyst, metallocene catalyst, or any other suitable means known to those of skill in the art.

However, and in addition to said polyolefins, other polymers that can be used include polystyrenes, poly(methyl)methacrylates, polycarbonate copolymers (e.g, bisphenol A and sebacic acid based copolymers, etc.), polycarbonate blends (e.g., polycarbonate/polyester blends etc.), polyvinyl acetate, polyvinyl butyral, polyethylene terephthalate (PET), nylon, etc. Additionally, polymers obtained from one or more monomers selected from alkyl carbonates, multifunctional acrylates, multifunctional methacrylates, cellulose acetates, cellulose triacetates, cellulose acetate propionate, nitrocellulose, cellulose acetate balynete, vinyl alcohol, vinyl chloride, vinylidene chloride, diacylidene pentaerythritol, etc.

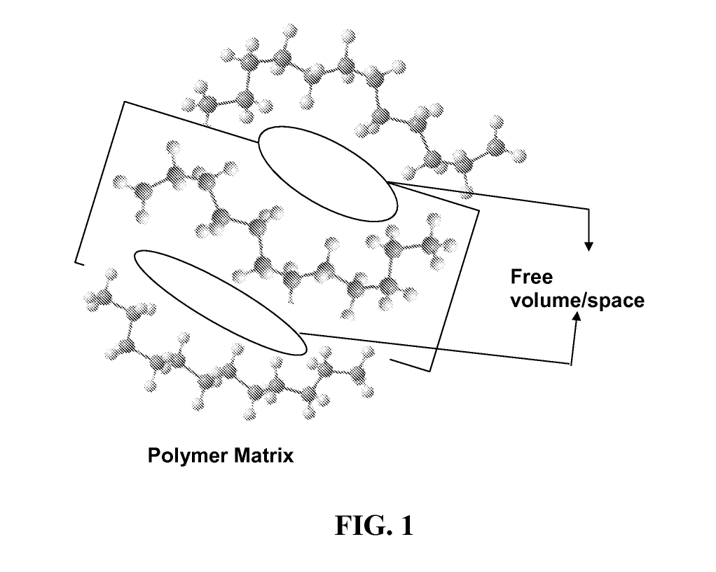

The resulting fast-switching back photochromic layers or films of the present invention have more free volume (see, e.g., FIG. 1) as compared to other polymers (e.g., thermoset or some polycarbonate polymers). Examples of products having such thermoset or polycarbonate polymer matrices lacking sufficient void space include automotive headlamp lenses, lighting lenses, sunglass lenses, eyeglass lenses, swimming goggles and SCUBA masks, safety glasses/goggles/visors including visors in sporting helmets/masks, windscreens in motorized vehicles (e.g., motorcycles, ATVs, golf carts), electronic display screens (e.g., e-ink, LCD, CRT, plasma screens), etc. Therefore, films or layers of such polymers and matrices having more free volume have not typically been used in such products. In the context of the present invention, however, it was surprisingly discovered that such films or layers due to their increased void space (See, FIG. 1) had the ability to allow photochromic compounds or dyes to quickly switch from an activated state (activated by a given stimulus) to an inactivated state (in the absence of said stimulus) in response to electromagnetic radiation (e.g., less than 10 minutes, 5 minutes or less, and 1 minute or less). The films of the present invention can therefore be beneficial to the aforementioned products to provide said products with color changing capabilities that can quickly change back to their beginning or inactivated color-state in the absence of a given stimulus. Still further, these films of the present invention can also be used with the more rigid substrates (e.g., wood, glass, cloth, paint, polymers and matrices (e.g., polycarbonates).

Notably, when the fast-switching back color changing layers of the present invention are used with such products or rigid substrates, the products or substrates have color changing capabilities without compromising the impact strength and/or optical clarity of the given product or substrate.

### B. Additional Color Changing Layers

In addition to the fast-switching color changing layers discussed above in section A, additional color changing layers can be used in the context of the present invention. These additional layers can be used with the fast-switching color changing layers in Section A to obtain stacks or laminates of color changing layers to produce a material that is capable of changing various colors in response to a given stimuli. Alternatively, these additional layers can be used without the fast-switching color changing layers in Section A to obtain stacks or laminates of color changing layers to produce a material that is capable of changing various colors in response to a given stimuli.

In one instance, the additional color changing layers can include thermoplastic polymers which can become pliable or moldable above a specific temperature, and return back to a more solid state upon cooling. There are a wide range of various thermoplastic polymers, and blends thereof, that can be used to make a color changing layer or material of the present invention. Some non-limiting examples include polyolefins (e.g., polypropylene, polyethylene, ethylene-propylene copolymers, propylene-butene copolymers, ethylene-propylene-butylene terpolymers, or blends thereof), polystyrenes, poly(methyl)methacrylates, polycarbonate copolymers (e.g, bisphenol A and sebacic acid based copolymers, etc.), polycarbonate blends (e.g., polycarbonate/polyester blends etc.), polyvinyl acetate, polyvinyl butyral, polyethylene terephthalate (PET), polyurethane, nylon, and blends and co-polymers thereof etc. Additionally, polymers obtained from one or more monomers selected from alkyl carbonates, multifunctional acrylates, multifunctional methacrylates, cellulose acetates, cellulose triacetates, cellulose acetate propionate, nitrocellulose, cellulose acetate balynete, vinyl alcohol, vinyl chloride, vinylidene chloride, diacylidene pentaerythritol, and blends and co-polymers thereof.

In a preferred embodiment of the present invention, polycarbonates (PCs) are used in combination with the fast-switching color changing layers in Section A. PCs include a particular class of thermoplastic polymers that are commercially available from a wide variety of sources (e.g., Sabic Innovative Plastics (Lexan®)). In a particularly preferred embodiment, Lexan® can be used in the context of the present invention. PCs typically have high impact-resistance and are highly transparent to visible light, with light transmission properties that exceed many types of glass products. Preferred examples of PCs include dimethyl cyclohexyl bisphenol or high-flow ductile (HFD) polycarbonates (e.g., bisphenol-A polycarbonate, sebacic acid copolymer). Generally, polycarbonates are polymers that include repeating carbonate groups (—O—(C═O)—O—). A well-known PC is bisphenol-A polymer, which has the following formula (I):

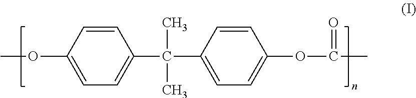

However, all types of polycarbonates, co-polymers, and blends thereof are contemplated in the context of the present invention. By way of example, and in addition to the dimethyl cyclohexyl bisphenol and high-flow ductile (HFD) polycarbonates (e.g., bisphenol-A polycarbonate, sebacic acid copolymer) mentioned above, WO 2013/152292 (the contents of which are incorporated into the present specification by reference) provides a wide range of PCs that can be used. In particular, “polycarbonates” can include polymers having repeating structural carbonate units of formula (II):

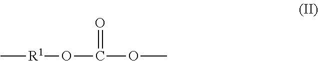

in which at least 60% of the total number of R¹ groups contain aromatic moieties and the balance thereof are aliphatic, alicyclic, or aromatic. In an embodiment, each R¹ is a C₆₋₃₀ aromatic group, that contains at least one aromatic moiety.

### C. Photochromic/Thermochromic/Electrochromic Compounds

Photochromic, thermochromic, and electrochromic compounds can be used with the fast-switching color changing layers of section A or the additional color changing layers of section B. In particular, such materials can be incorporated into these layers to provide the color-changing capabilities to said layers to obtain a desired color changing effect in response to a selected stimulus or selected stimuli (e.g., electromagnetic radiation, heat, electricity, or combinations thereof). Non-limiting examples of these materials are provided below.

1. Photochromic Compounds

Photochromism typically refers to compounds that undergo a photochemical reaction where an absorption band in the visible part of the electromagnetic spectrum changes in strength or wavelength. This change results in the compound changing color (e.g., from “water white” to colored). In many cases, an absorbance band is present in only one form. The degree of change required for a photochemical reaction to be dubbed “photochromic” is that which appears visibly dramatic by visual inspection. Therefore, while the trans-cis isomerization of azobenzene is considered a photochromic reaction, the analogous reaction of stilbene is not. Given that photochromism is a species of a photochemical reaction, almost any photochemical reaction type may be used to produce photochromism with appropriate molecular design. Some of the most common processes involved in photochromism are pericyclic reactions, cis-trans isomerizations, intramolecular hydrogen transfer, intramolecular group transfers, dissociation processes and electron transfers (oxidation-reduction).

Another feature of photochromism is two states of the molecule should be thermally stable under ambient conditions for a reasonable time. For instance, nitrospiropyran (which back-isomerizes in the dark over ˜10 minutes at room temperature) is considered photochromic. All photochromic molecules back-isomerize to their more stable form at some rate, and this back-isomerization is accelerated by heating. There is therefore a close relationship between photochromic and thermochromic compounds. The timescale of thermal back-isomerization is important for applications, and may be molecularly engineered. Photochromic compounds considered to be “thermally stable” include some diarylethenes, which do not back isomerize even after heating at 80 C for 3 months.

Photochromic chromophores are dyes and operate according to well-known reactions. Molecular engineering to fine-tune their properties can be achieved relatively easily using known design models, quantum mechanics calculations, and experimentation. In particular, the tuning of absorbance bands to particular parts of the spectrum and the engineering of thermal stability have received much attention.

In the context of the present invention, a photochromic compound or dye refers to a molecule that can exhibit change in color under the influence of certain frequencies of light. By way of example, a photochromic compound or dye can change shape under the influence of light by absorbing said light, thereby resulting in a shift in the color of the compound (i.e., color change). The shift can be from a colorless or clear state to a colored state or from a first color to a second color or from a colored state to a colorless or clear state. Such compounds or dyes can also switch back from their activated state to their inactivated state by removal of the said light radiation and under the influence of temperature. Non-limiting examples of photochromic compounds or dyes that can be used in the context of the present invention (i.e. switches back and forth between an activated and inactivated state) include chromenes, spiroxazines, spiropyrans, fulgides, fulgimides, anils, perimidinespirocyclohexadienones, stilbenes, thioindigoids, azo dyes, a diarylethenes, napthopyrans, etc., or any combination thereof. In particular aspects, such dyes or molecules can be obtained from Vivimed Labs Europe Ltd. under the trade name ReversacolTM Photochromic Dyes, which offers a variety of dyes that can be activated in response to ultraviolet light spectrum. Some compounds or dyes cannot or are sufficiently slow to switch back to their inactivated state and thus are considered irreversible photochromic compounds.

Photochromic dyes can have the trivial names of Storm Purple, Aqua Green, Sea Green, Plum Red, Berry Red, Corn Yellow, Oxford Blue and the like. Corn Yellow and Berry Red are benzopyran compounds, while Storm Purple, Aqua Green, Sea Green, and Plum Red are spiro-oxazines. Generic structures of the spiro-oxazine dyes are represented by the formulas (II) to (IV):

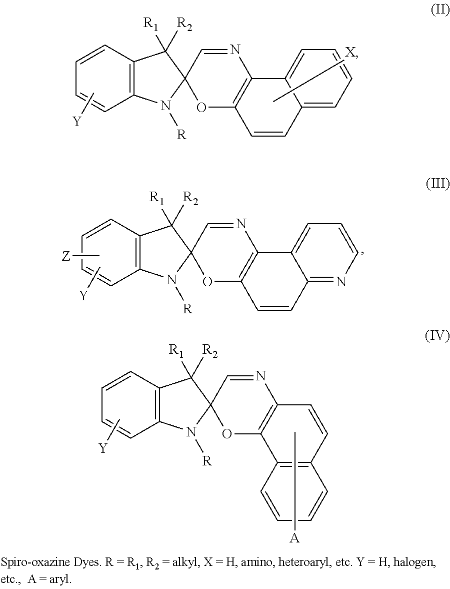

Naphthopyran dyes can be represented by the general formula (V):

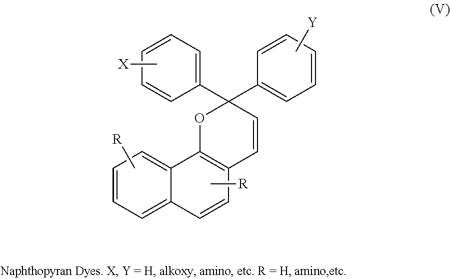

2. Thermochromic Compounds

In the context of the present invention, thermochromic compounds include organic compounds or pigments that effectuate a reversible color change when a specific temperature threshold is crossed. Thermochromic pigments can include three main components: (i) an electron donating coloring organic compound, (ii) an electron accepting compound and (iii) a solvent reaction medium determining the temperature for the coloring reaction to occur. One example of a commercially available, reversible thermochromic pigment is ChromaZone® Thermobatch Concentrates available from Thermographic Measurements Co. Ltd. Thermochromic pigments and the mechanism bringing about the temperature triggered color change are well-known in the art and are for example described in U.S. Pat. Nos. 4,826,550 and 5,197,958. Other examples of thermochromic pigments are described in U.S. Patent Application Publication No. 2008/0234644A1. Alternatively, the thermosensitive pigment may be of a microcapsule type which is known in the art of thermosensitive pigments.

3. Electrochromic Compounds

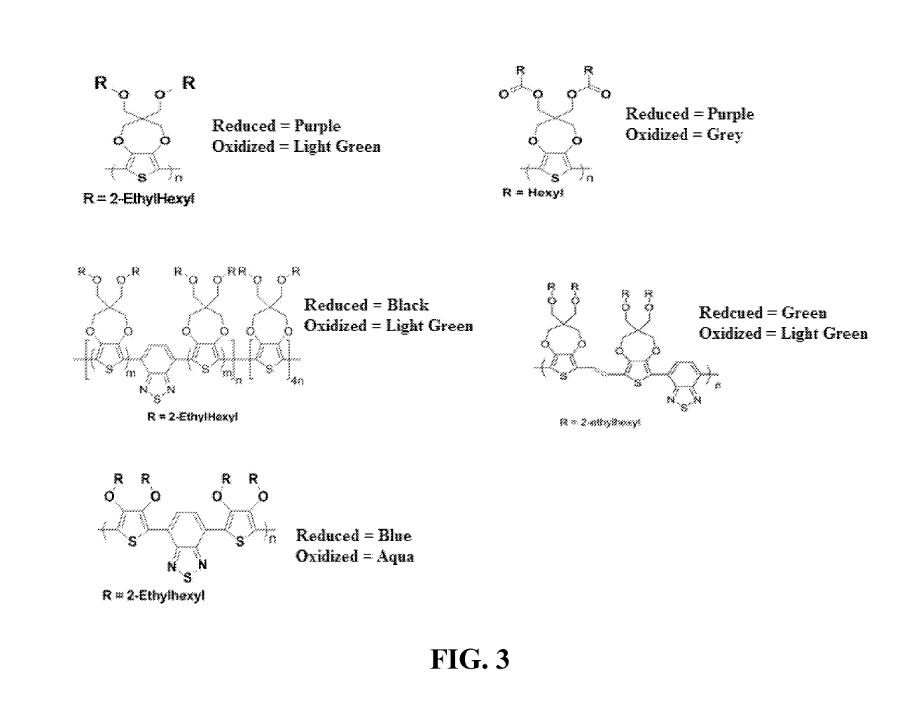

Electrochromism is the phenomenon displayed by some chemical compounds that have a reversibly changeable color when a voltage is applied. The electrochromic material may not have a color in the absence of an electric field and then may display a certain color when an electric field is applied, for example, by an external source. Alternatively, the electrochromic material may have a color in the absence of an electric field and then may display no color when an electric field is applied. Examples of electrochromic materials include conjugated polymers, organic compounds such as pyridine, aminoquinone, and azine compounds, and inorganic compounds such as tungsten oxides, molybdenum oxides, and the like. Typically, these electro-optic changes occur in the visible region of the spectrum with the material switching colors upon a change in applied potential. Conjugated polymers are particularly useful in the context of the present invention due to their color tunability, high optical contrasts, fast switching speeds, and processability. FIG. 3 provides an illustration of various polymers that can be used in the context of the present invention, and their respective color changes in response to an electrical stimulus.

### D. Permanent Colorants and Dyes

Colorants such as pigments can be used to impart a permanent color to a given layer of the multi-layered color changing materials of the present invention. By way of example, a transparent polymeric or non-polymeric layer can be given a permanent color by using a permanent pigment such that the layer does not exhibit reversible color shifting characteristics in response to a given stimulus such as light, heat, or electricity. Alternatively, such colorants can be used in combination with the aforementioned photochromic, thermochromic, and electrochromic materials such that the layer has a particular hue due to the colorant, but shifts color or increases the intensity of the hue in response to a given stimulus such as light, heat, or electricity. Non-limiting examples of pigments that can be used in any of the layers of the color changing materials of the present invention include metal-based pigments (e.g., cadmium pigments (e.g., cadmium yellow, cadmium red, cadmium green, cadmium orange, cadmium sulfoselenide), chromium pigments (e.g., chrome yellow and chrome green), cobalt pigments (e.g., cobalt violet, cobalt blue, cerulean blue, aureolin (cobalt yellow)), copper pigments (e.g., azurite, Han purple, Han blue, Egyptian blue, Malachite, Paris green, Phthalocyanine Blue BN, Phthalocyanine Green G, verdigris, viridian), iron oxide pigments (e.g., sanguine, caput mortuum, oxide red, red ochre, Venetian red, Prussian blue), lead pigments (e.g., lead white, cremnitz white, Naples yellow, red lead), manganese pigments (e.g., manganese violet), mercury pigments (e.g., vermilion), titanium pigments (e.g., titanium yellow, titanium beige, titanium white, titanium black), and (zinc pigments (e.g., zinc white, zinc ferrite)), or any combinations thereof. Non-limiting examples of other pigments include carbon pigments (e.g., carbon black, ivory black), clay earth pigments or iron oxides (e.g., yellow ochre, raw sienna, burnt sienna, raw umber, burnt umber), and ultramarine pigments (e.g., ultramarine or ultramarine green shade).

Organic compounds (e.g., synthetic or natural dyes) and irreversible photochromic compounds that impart permanent color to one or more layers can be used in combination with the photochromic, thermochromic and/or electrochromic materials. Non-limiting examples or permanent organic dyes include phthalones, pryophthalone dyes, perylene dyes etc., or any combination thereof. A non-limiting example of the perylene dye is anthra[2,1,9-def:6,5,10-d′e′f′]diisoquinoline-1,3,8,10(2H,9H)-tetrone, 2,9-bis(2-ethylhexyl)-5,6,12,13-tetrakis(4-nonylphenoxy) (Chemical Abstract No. 1210881-03-0). These dyes and other dyes are described in U.S. Pat. No. 8,304,647 to Bhaumik et al. can be used as a non-photochromic dye. Non-limiting examples of pyrophthalone dyes is 1H-indene-1,3(2H)-dione, 4,5,6,7-tetrachloro-2-(2-pyridinyl) (CAS No. 343232-69-9). This dye and other dyes described in U.S. Patent Application Publication No. 2014-0357768 to Sharma et al. can be used as a non-photochromic dye. Non-limiting examples of irreversible photochromic compounds are commercially available from Olikrom Smart Pigments (France) and Sky-Rad Ltd. (Israel).

### E. Methods of Making Photochromic Materials

The single or multi-layered color changing materials of the present invention can be made by straightforward and cost-efficient steps that are performed under conditions that reduce or prevent damage to the photochromic, electrochromic, or thermochromic materials.

1. Making the Single Layered Photochromic Materials

A photochromic material can be made by the non-limiting procedure of combining a photochromic compound or dye material with a polymeric solution or oligomeric solution or mixture, casting or extruding a film therefrom, and, if required, at least partially setting the film. Polymer powder can be used (e.g., in Kg scale), and photochromic dye can be used in ppm level (see, e.g., Tables 6 & 7 below). Processing temperatures can range from 150-250° C.). The resulting polymeric film includes a polymer with a more void space when compared to the other layers. The thickness of this film can be modified as needed. In preferred aspects, the thickness of this film ranges from 10 μm to 4 mm. In some embodiments, the photochromic dye, electrochromic material or thermochromic material and/or additional compounds are delivered to specific portions of the resulting polymeric film (for example, in the center of the film, around the exterior portions of the film, or dispersed throughout the film).

2. Making the Multi-Layered Photochromic Materials

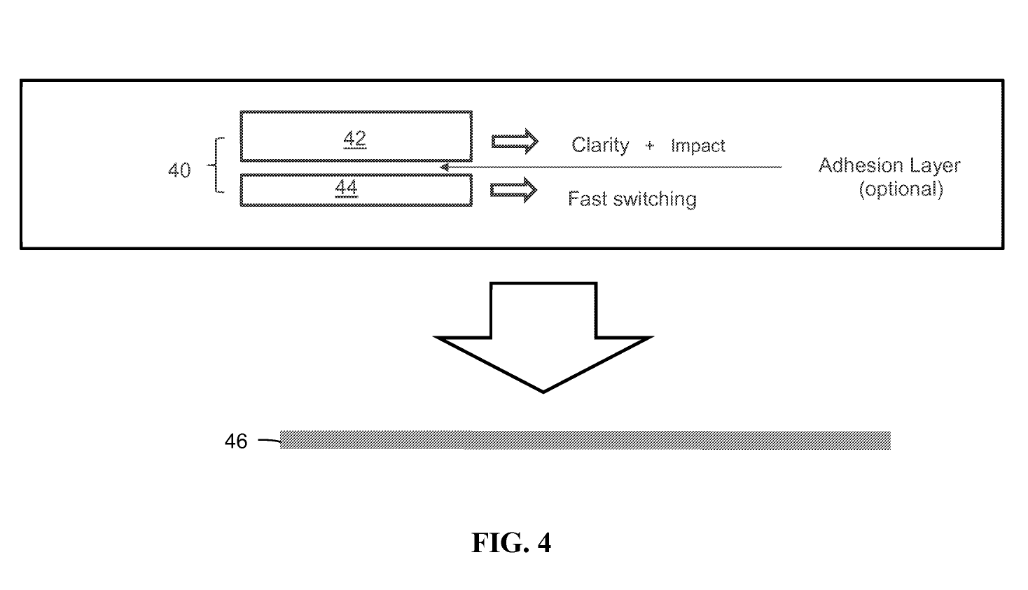

The multi-layered color changing materials of the present invention can be made by straightforward and cost-efficient steps that are performed under conditions that reduce or prevent damage to the photochromic, electrochromic, or thermochromic materials. In particular, there are two alternatives, a lamination process and a co-extrusion process, which are illustrated in FIG. 4. In some embodiments, the photochromic dye, electrochromic material or thermochromic material and/or additional compounds are delivered to specific portions of the resulting polymeric layers (for example, in the center of the layer, around the exterior portions of the film, or dispersed throughout the layers).

The lamination process 40 can include the following steps:
(a) obtaining a first polymeric film 42 that includes a thermoplastic polymer or copolymer or a polymeric blend of said polymer or copolymer. Such films are commercially available (e.g., SABIC) or can be easily prepared by processes disclosed in this specification and those known in the art. In preferred aspects, the thickness of this film can range from 10 μm to 4 mm. The film can include a photochromic compound such that the film is capable of reversibly changing from color 1 to color 2 in response to electromagnetic radiation. Such films can be prepared by using the following non-limiting procedure: combining a photochromic compound or dye material with a polymeric solution or oligomeric solution or mixture, casting or extruding a film therefrom, and, if required, at least partially setting the film. Polymer powder can be used (e.g., in Kg scale), and photochromic dye can be used in ppm level (see, e.g., Tables 6 & 7 below). Processing temperatures can range from 150-250° C.).
(b) obtaining a second polymeric or non-polymeric film or layer 44. This film or layer can also include a photochromic compound or can include a thermochromic or electrochromic material or combinations thereof that allow this layer to reversibly change from color 3 to color 4 in response to a stimulus (e.g., electromagnetic radiation, heat, or electricity). The thickness of this film can be modified as needed to match the optical clarity of the first film or the optical parameters desired for a given application. In preferred aspects, the thickness of this film ranges from 10 μm to 4 mm. Such films can be prepared by using the following non-limiting procedure: combining a photochromic compound or dye material with a polymeric solution or oligomeric solution or mixture, casting or extruding a film therefrom, and, if required, at least partially setting the film. Polymer powder can be used (e.g., in Kg scale), and photochromic dye can be used in ppm level (see, e.g., Tables 6 & 7 below). Processing temperatures can range from 150-250° C.).
(c) pressing the first film 42 and second film 44 together such that the first and second films adhere to one another and form color changing material 46. The following conditions can be used to obtain sufficient adhesion of these films: temperature range for lamination can be 100 to 250° C., and pressure range for lamination can be 50 to 200 psi.

For the co-extrusion process, the following steps can be used:
(a) extruding in a first extruder a first composition comprising the thermoplastic polymer or copolymer or polymeric blend thereof and a photochromic compound.
(b) simultaneously or substantially simultaneously extruding in a second extruder a second composition comprising a thermoplastic or a non-thermoplastic polymer and optionally a photochromic, thermochromic, or electrochromic material or combinations thereof.
(c) introducing the extruded first composition 42 and second composition 44 into a die such that the first and second compositions contact one another to form the multi-layered material of the present invention. The resulting thicknesses of each of the first and second layers preferably range from 10 μm to 4 mm.
(d) solidifying both the first and second layers (e.g., by cooling) thereby forming a self-supporting multi-layer film 46 of the present invention.
(e) optionally heat treating the photochromic material at a temperature range of 100 to 200° C.

The polymers used in the first and second layers or films along with the photochromic, thermochromic, and electrochromic materials can be used in amounts (or ratios) such that the resulting film or layer (or the entire multi-layered material) exhibits desired optical properties without and in the presence of a given stimulus. For example, the amount and types of photochromic/thermochromic/electrochromic materials can be selected such that the resulting individual films or the entire material may be clear or colorless in the absence of a given stimulus (e.g., electromagnetic radiation) and may exhibit a desired resultant color in the presence of the stimulus. The precise amount of the photochromic/thermochromic/electrochromic materials that may be utilized is not critical provided that a sufficient amount is used to produce the desired effect. The particular amounts may depend on a variety of art-recognized factors, such as but not limited to, the absorption characteristics of the chromic materials, the color and intensity of the color desired upon activation, and the method used to incorporate the chromic materials into the polymeric layers of the present invention. Although not limiting herein, according to various non-limiting embodiments disclosed herein, the amount of the photochromic/electrochromic/thermochromic materials incorporated into the polymeric layers of the present invention can range from 0.01 to 20 weight percent (e.g., from 0.05 to 15, or from 0.1 to 5 weight percent), based on the total weight of each layer into which the chromic material is incorporated.

Similarly, each layer can be further colored with pigments to create opaque or permanently colored translucent layers. Similarly, additives can be added to the multi-layered color changing materials of the present invention. For instances, additives can be added to any of the layers of the materials of the present invention to achieve a desired effect. The amounts of such additives can range from 0.001 to 40 wt. %. In addition to the pigments, non-limiting examples of such additives include plasticizers, ultraviolet absorbing compounds, optical brighteners, ultraviolet stabilizing agents, heat stabilizers, diffusers, mold releasing agents, antioxidants, antifogging agents, clarifiers, nucleating agents, phosphites or phosphonites or both, light stabilizers, singlet oxygen quenchers, processing aids, antistatic agents, fillers or reinforcing materials, or any combination thereof. Non-limiting examples of ultraviolet light absorbing compounds include those capable of absorbing ultraviolet A light comprising a wavelength of 315 to 400 nm (e.g., avobenzone (Parsol® 1789, AbcamBiochemicals®, USA), bisdisulizole disodium (Neo Heliopan® AP, Symrise, Germany), diethylamino hydroxybenzoyl hexyl benzoate (Uvinul® A Plus, BASF), ecamsule (Mexoryl SX, L'Oreal, France), or methyl anthranilate, or any combination thereof) or those that are capable of absorbing ultraviolet B light comprising a wavelength of 280 to 315 nm (e.g., 4-aminobenzoic acid (PABA), cinoxate, ethylhexyl triazone (Uvinul® T 150, BASF), homosalate, 4-methylbenzylidene camphor (Parsol® 5000), octyl methoxycinnamate (octinoxate), octyl salicylate (octisalate), padimate O (Escalol® 507, Ashland Inc., USA), phenylbenzimidazole sulfonic acid (ensulizole), polysilicone-15 (Parsol® SLX), trolamine salicylate, or any combination thereof), or those that are capable of absorbing ultraviolet A and B light comprising a wavelength of 280 to 400 nm (e.g., bemotrizinol (Tinosorb S, BASF), benzophenones 1 through 12, dioxybenzone, drometrizole trisiloxane (Mexoryl XL), iscotrizinol (Uvasorb® HEB, 3V Sigma, Italy), octocrylene, oxybenzone (Eusolex 4360, Merck KGaA, Germany), or sulisobenzone, or any combination thereof). Such additives can be compounded into a masterbatch with the desired polymeric resin.

### F. Tuning

Each layer of the color changing material of the present invention can be designed such that it's resting or non-stimulated state is optically clear or is colored (either transparently, translucently or opaquely colored). For an optically clear resting state, optically clear polymers, including those described throughout the specification (e.g., polyolefins, polycarbonates, etc.), can be used. For a colored resting state, pigments and other dyes can be incorporated into the layer to produce a desired color. Also, opaque polymers can be used to produce a desired colored resting state.

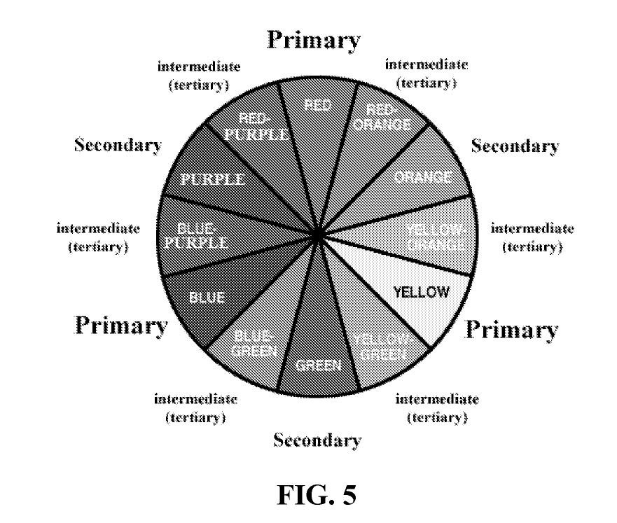

Further, each layer of the color changing material can include various photochromic, thermochromic, or electrochromic materials, or combinations thereof. These combinations can produce different colors and color intensities (see FIG. 5, which is a standard color wheel that can be used to design the various colors produced for a given color changing material of the present invention). For example, a combination of photochromic material that turns blue in response to visible light (blue photochromic material) with photochromic material that turns yellow in response to visible light (yellow photochromic material) can produce an overall green color in the presence of visible light. Even further, varying the amounts or ratios of one material over another can produce various shades or tints of colors (e.g., a 2:1 ratio of blue photochromic material over yellow photochromic material would result in a more blue-green color. By comparison, a ratio of 1:2 of blue photochromic material over yellow photochromic material would result in a more yellow-green color).

Also, the thickness of each layer of the color changing material of the present invention can be varied to obtain a desired time-period in which the color change occurs. The thickness can also be varied to obtain a desired color intensity or shade of color. For instance, if the thickness of a given layer is increased, then it could take a longer period of time for a given stimulus to reach a responsive material (e.g., photochromic, thermochromic, or electrochromic material), thereby causing an increase in the time-period in which the color change occurs. Further, the longer travel time could result in a reduced or filtered stimulus reaching the responsive material, which could affect color intensity or shade. By comparison, if the thickness of the layer is decreased, then the color intensity or shade could be increased and the time-period of the color change decreased—there is less polymeric or non-polymeric material in the layer to inhibit or limit a given stimulus reaching a responsive material (e.g., photochromic, thermochromic, or electrochromic material). Notably, the thickness of the top or outermost layer can affect all of the layers below this outermost layer by acting as an overall stimulus filter for the lower-level layers.

Additionally, the positioning of photochromic, thermochromic, or electrochromic responsive material in a given layer can be used to obtain a desired color intensity or time-period for the color change. Similar to the thickness of layers, the positioning of the responsive material within a layer can either increase or decrease the travel time that a given stimulus takes to reach the responsive material. Further, the stimulus can be stronger or weaker depending on the positioning of the responsive material in the layer (e.g., the material used to make the layer—polymeric material, non-polymeric material, additives, etc.—can act as a filter for the stimulus by diffracting or absorbing the stimulus). Positioning of the responsive material within a desired portion of the layer may impart color to the desired portion while leaving other portions or the layer or photochromic material unchanged in color upon exposure to a stimulus. A non-limiting example includes inclusion of the responsive material in the center of a layer so that upon exposure of the photochromic material to a stimulus only the center of the photochromic material changes color. Upon removal of the stimulus the center of the photochromic material quickly returns to the original color.

Therefore, desired time-periods for color changes as well as desired colors and color intensities can be produced in the context of the present invention by: (1) combining various photochromic, thermochromic, or electrochromic materials in single layers or stacking multiple layers onto one another; (2) varying the concentrations/amounts/ratios of photochromic, thermochromic, or electrochromic materials used in the layers; (3) varying the thicknesses of the photochromic and non-photochromic layer(s); (4) varying the position or location (e.g., depth within layer or one side of the layer, etc.) of the photochromic, thermochromic, or electrochromic materials; and (5) using non-photochromic layers that have resting or set or permanent colors. By varying these features, the color changing materials of the present invention can be tuned to have a desired color or color intensity at desired time-periods.

The colors that can be produced are wide ranging. The color wheel in FIG. 5 provides non-limiting examples such as primary colors (e.g., red, blue, yellow), secondary colors (e.g., orange, green, purple), and various tertiary colors (yellow-orange, red-orange, red-purple, blue-purple, blue-green, and yellow-green). Secondary colors can be formed by mixing two primary colors. Tertiary colors can be formed by mixing primary and secondary colors. Various color shades can be produced by combing various colors from the color wheel. Additionally, various tints of each color can be produced by adding white to a given color. Various shades can be produced by adding black to a given color. The tones of each color can be modified by adding gray to a given color.

### G. Multi-Layered Photochromic Material

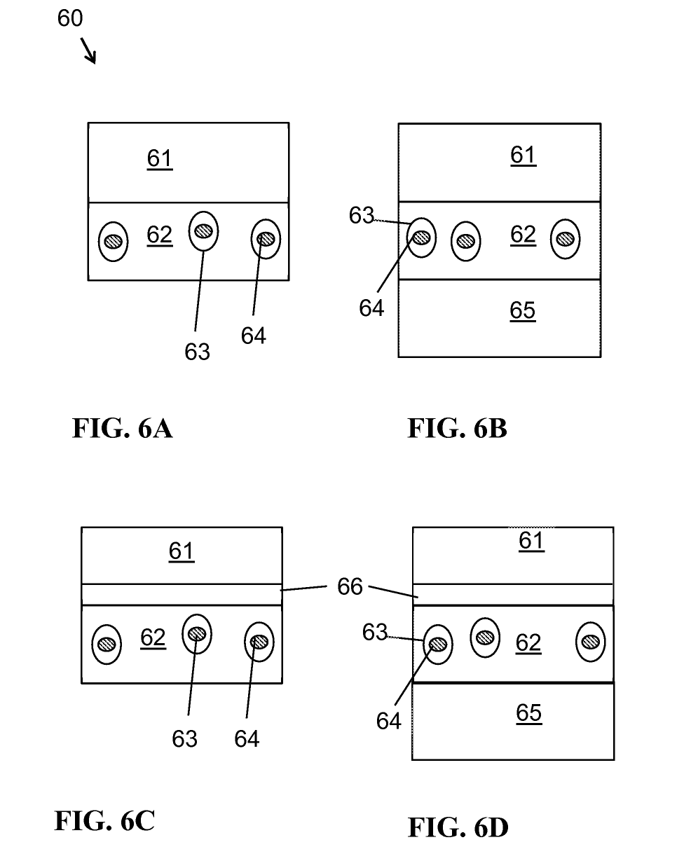

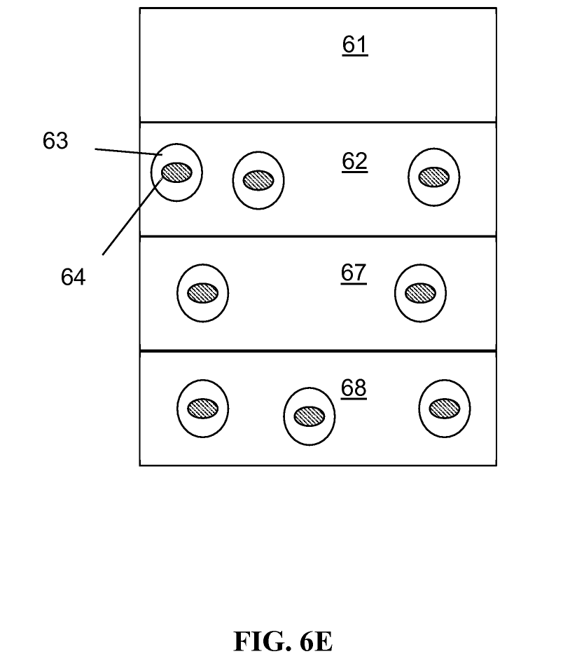

Referring to FIG. 6A, the multi-layered photochromic material 60 of the present invention can take a variety of forms. The multi-layered photochromic material can include one or more photochromic dyes where at least one of the photochromic dyes is capable of switching back upon removal of the stimulus in a rapid manner (e.g., less than 10 minutes, 5 minutes or 1 minute). Further, it can be designed such that it is transparent, optically clear, translucent or opaque prior to being subjected to electromagnetic/thermal/electric stimuli. In preferred aspects, said material 60 is optically clear or transparent or translucent prior to being subjected to stimuli. FIG. 6A illustrates a cross-section view of a bilayer material 60 that includes a first layer or film 61 in contact with a second thermoplastic polymeric layer or film 62. Contact refers to at least a portion of a surface of the first film 61 contacting at least a portion of a surface of the second film 62. In preferred aspects, at least 10, 20, 30, 40, or up to 50% of the surfaces of the first and second films can be in contact with one another. The first layer 61 can be polymeric or non-polymeric layer. This layer 61 can provide support for the thermoplastic layer 62. The second layer 62 can include free volume or spaces 63 within the polymeric matrix. The free volume or spaces 63 can be modified by selection of a particular polymer or modifying the amounts of polymers in instances where a blend of polymers is used. This free volume or spaces 63 allows photochromic compounds 64 to efficiently change shape from an inactivated state to an activated state in response to electromagnetic radiation with rapid return to the original color upon removal of the stimulus (e.g., fast-switching back to original color within 10, 9, 8, 7, 6, 5, 4, 3, 2, 1, minutes or less once the stimulus is removed). Further, and although not shown, the first layer 61 can also include photochromic compounds 64 or thermochromic or electrochromic material. Similarly, the second layer 62 can also include thermochromic or electrochromic material.

Referring to FIG. 6B, a substrate 65 can be used to support the bilayer material 60. The substrate can be in direct contact with the second layer 62 or can be in direct contact with the first layer 61 or can be separated with additional layers between said first or second layers 61 and 62. The substrate 65 can be additional polymeric layers, non-polymeric layers, articles of manufacture (e.g., glass, monitors, furniture, buildings, walls, etc.). The multi-layered color fast color changing material 60 can be affixed to the substrate with an adhesive or attachment devices (e.g., nails, screws, clips, etc.).

Referring to FIGS. 6C and 6D, the first layer 61 can be adhered to the second layer 62 with an adhesive 66. Non-limiting examples of such adhesives include polyvinyl acetate (PVA), polyvinyl butyral (PVB), and others known in the art.

Referring to FIG. 6E, the photochromic material 60 can be a multi-layered material in which the first and second layers 61 and 62 can be attached to third 67 and fourth 68 layers. Although not shown, additional layers (e.g., 5, 6, 7, 8, or more) can be used, and the additional layers 67 and 68 can be attached to the first layer 61 or the second layer 62 or both the first and second layers 61 and 62. These additional layers can be polycarbonate layers, less rigid polymeric layers, non-polymeric layers (e.g., glass, metal, ceramic, etc.). Additional non-limiting examples of layers 67 and 68 include abrasion resistant films and coating (e.g., organosilanes, organosiloxanes, silica, titania, zirconia), UV-shielding coatings or films, anti-reflective coatings or films, oxygen barrier-coatings or films, conventional photochromic coatings, polarizing coating or films, anti-static coatings or films, oleophobic/hydrophobic or anti-soil or anti-fouling coatings or films, anti-fogging films, etc. In some embodiments, the photochromic material is used for outdoor applications and a light stabilized external layer can include additives described herein that are able to reduce photobleaching or fading of the photochromic dye. In some instances, one or more top layers can be used to inhibit gas migration into the layer (e.g., an oxygen barrier layer).

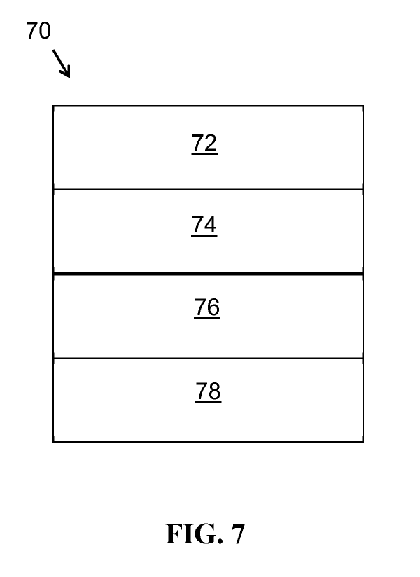

By way of example, and with reference to FIG. 7, a multi-layered photochromic material 70 is illustrated. In FIG. 7, a first layer 72 can include a polymeric layer that has good barrier properties and scratch resistance (for example, a polymer made from a methacryloyloxyethyl benzyl dimethylammonium chloride (DMBC)). This layer can inhibit oxygen from entering the other layers so that the mechanical and fatigue properties of the photochromic mechanical are not diminished. A second layer 74 can include a polymer and a dye (for example, a polycarbonate (PC) resin and a dye. A commercially available polycarbonate resin is XYLEXTM (SABIC Innovative Plastics). Layer 74 can be a fast fading layer, but have properties that are resistant to acids (for example, body lotions). A third layer 76 can include a polymer blend and a dye. Layer 76 can be a polypropylene (PP) and polyethylene (PE) blend. The fourth layer, layer 78, can be a polycarbonate layer and a dye. Layer 78 can also have fast fading properties when light exposure is removed and have better adhesive properties than layer 76. The combination of layers 72, 74, 76 and 78 control color fading. This set-up can control the rate of color change in response to electromagnetic radiation with the combination of dyes as well as provide a material that has optical clarity and sufficient barrier and scratch resistant properties.

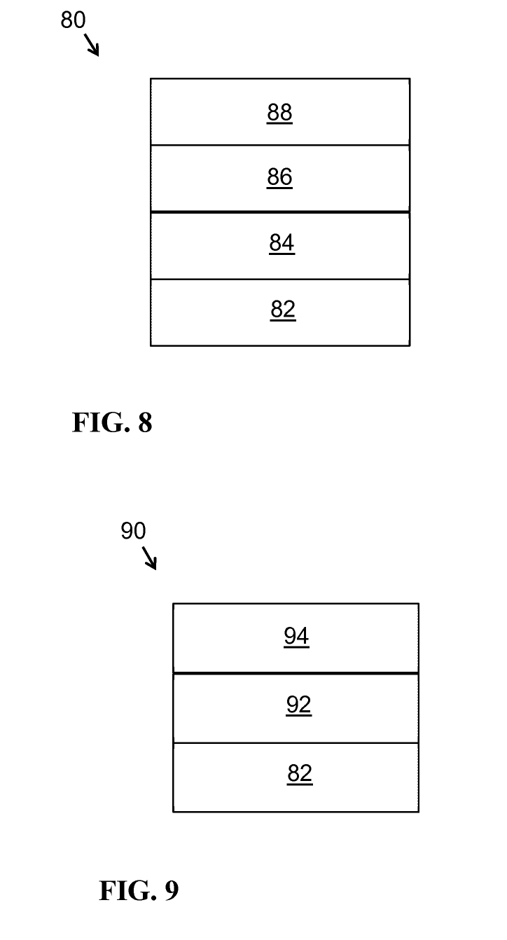

Referring to FIG. 8, a non-limiting tri-layered color changing (photochromic) material 80 of the present invention is affixed to an interior wall 82 that is painted white (e.g., a wall in a home or apartment or office space, etc.). A thermochromic layer 84 is directly attached (e.g., with a transparent adhesive) to the surface of the interior wall. The thermochromic layer 84 is a polymeric layer having a thermochromic material incorporated therein and is designed to have a green color at temperatures of equal to or less than 30° C. and to be colorless at temperatures greater than 30° C. An electrochromic layer 86 is disposed onto the thermochromic layer 84 (e.g., by co-extrusion or lamination). The electrochromic layer 86 is a polymeric layer having an electrochromic material incorporated therein and is designed to have a colorless state in the absence of an electrical stimulus (e.g., the material 80 can be wired to a wall switch) and a red color in the presence of an electrical stimulus). A photochromic layer 88 is disposed onto the electrochromic layer 86 (e.g., by co-extrusion or lamination). The photochromic layer 88 is a thermoplastic polymeric layer having a photochromic material incorporated therein and is designed to have a colorless state in the absence of visible light (e.g., sunlight or non-natural visible light) and a blue color in the presence of visible light. Thus, the tri-layered color material 80 could be used in the following manner. The color of the wall will appear green when the temperature is equal to or less than 30° C., without the electrical stimulus and in low light level conditions. Increases the light in the room (e.g., turning on a lamp or more light filtering in from the sun such as morning to afternoon light) would allow the photochromic layer 88 to be stimulated towards the color blue, thus creating a more blue-green color for the wall. If the temperature in the room rises to greater than 30° C. (while in the presence of light), then the color of the wall turn towards blue. If an electrical stimulus is then applied (e.g., turning on a wall-switch), the electrochromic layer 86 will go from colorless to red, thus creating a purple color on the wall. Then reducing the light level in the room will push the color of the wall towards red. Cooling the room down to 30° C. or less will then push the color of the wall to orange. Turning off the wall switch will then return the color of the wall to green.

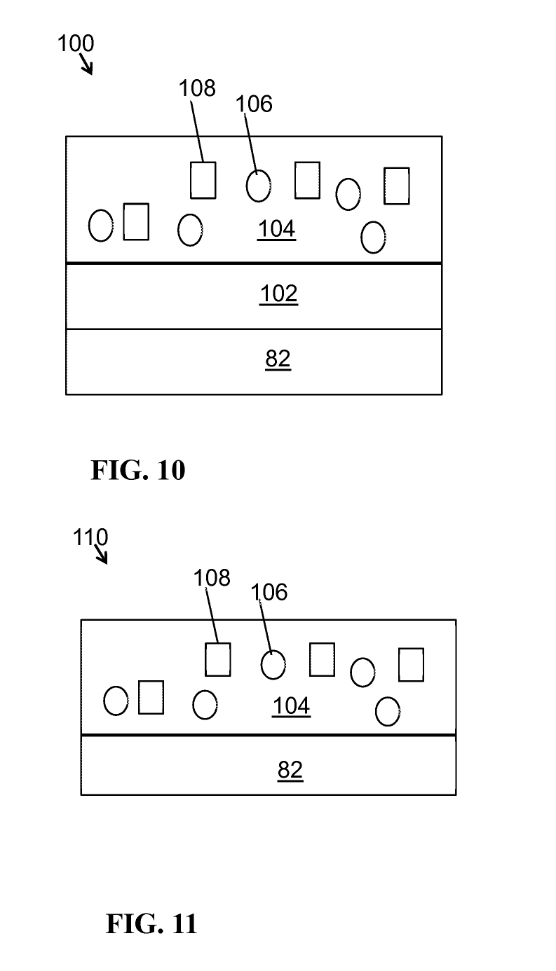

FIG. 9 provides another non-limiting embodiment of the present invention. In particular, a bi-layered photochromic material 90 of the present invention is affixed to an interior wall 82 that is painted white (e.g., a wall in a home or apartment or office space, etc.). The material 90 includes a first photochromic layer 92 that is directly attached (e.g., with a transparent adhesive) to a surface of the interior wall. This first layer 92 includes a photochromic compound that is activated by visible light, which allows the first layer 92 to shift from a colorless transparent state to yellow in the presence of visible light (e.g., house lamp, sunlight, etc.). A second photochromic layer 94 is disposed onto a surface of the first photochromic layer 92 (e.g., by co-extrusion or lamination). The second layer 94 is designed to have a transparent colorless state in the absence of UV light and a blue color in the presence of UV light. Notably, both layers 92 and 94 can each individually be thermoplastic or thermoset polymeric layers. Thus, the bi-layered color material 90 could be used in the following manner. The color of the wall will appear white in the absence of sunlight and in the absence of a non-natural visible light source (e.g., at nighttime). In the presence of sunlight in which UV light has not been filtered out (e.g., by a window), the color of the wall will begin to shift from white to green due to UV light from the sun activating the photochromic compound in layer 94 and visible light from the sun activating the photochromic compound in layer 92 (blue+yellow=green). Then if a non-natural visible light source (e.g., incandescent, fluorescent, LED light source, etc.) is turned on (e.g., from a lamp), the color of the wall will shift to a yellow-green color due to additional visible light stimulation. If sunlight is then removed (e.g., closing blinds or curtains in a room or as day turns to night), the color of the wall will shift towards yellow via deactivation of the photochromic compound in layer 94. Then, if the non-natural visible light source is removed (e.g., lamp is turned off), the color of the wall will shift from yellow back to white via deactivation of the photochromic compound in layer 92. The same type of effect could also be achieved by mixing different photochromic compounds in a single layer (see FIG. 10).

FIG. 10 is a non-limiting bi-layer photochromic material 100 of the present invention. The material 100 includes a first electrochromic layer 102 that is directly attached (e.g., with a transparent adhesive) to a surface of an interior wall 82 that is painted white. This first layer 102 includes an electrochromic compound that is activated by electricity, which allows the layer 102 to shift from a colorless transparent state to red in the presence of electricity (e.g., it can be coupled to a wall switch in a house). A second photochromic layer 104 is disposed onto a surface of the first photochromic layer 102 (e.g., by co-extrusion or lamination). The second layer 104 includes a first photochromic compound 106 that is activated by UV light (e.g., activation causing a color change from colorless to blue) and a second photochromic compound 108 that is activated by visible light (e.g., activation causing a color change from colorless to yellow). The compounds 106 and 108 are dispersed throughout the second layer 104. The second layer 104 is designed to have a transparent colorless state in the absence of UV and visible light, a color of blue in the presence of UV light and the absence of visible light, a color of yellow in the presence of visible light and in the absence of UV light, and a color of green in the presence of both UV and visible light (e.g., light from the sun). The intensity of the color shifts can be modified by varying the amount of photochromic (as well as electrochromic and thermochromic compounds) in a given layer. This photochromic material 100 can change colors by including and excluding the various stimuli needed to change the colors of the layers of the material 100, similar to the embodiments discussed above.

FIG. 11 is a mono-layer photochromic material 110 of the present invention. It is similar to the embodiment in FIG. 10, except that it no longer includes the electrochromic layer 102.

### H. Applications for the Photochromic Materials

The photochromic materials of the present invention can be used in a wide variety of applications. For instance, and as exhibited in the examples, the materials have sufficient optical properties and strength such that they can be used in optical applications such as Examples of photochromic materials of the present invention include, but are not limited to, optical elements, displays, windows (or transparencies), mirrors, and liquid crystal cells. As used herein the term “optical” means pertaining to or associated with light and/or vision. The optical elements according to the present invention may include, without limitation, ophthalmic elements, display elements, windows, mirrors, and liquid crystal cell elements. As used herein the term “ophthalmic” means pertaining to or associated with the eye and vision. Non-limiting examples of ophthalmic elements include corrective and non-corrective lenses, including single vision or multi-vision lenses, which may be either segmented or non-segmented multi-vision lenses (such as, but not limited to, bifocal lenses, trifocal lenses and progressive lenses), as well as other elements used to correct, protect, or enhance (cosmetically or otherwise) vision, including without limitation, magnifying lenses, protective lenses, visors, goggles, as well as, lenses for optical instruments (for example, cameras and telescopes). As used herein the term “display” means the visible or machine-readable representation of information in words, numbers, symbols, designs or drawings. Non-limiting examples of display elements include screens, monitors, and security elements, such as security marks. As used herein the term “window” means an aperture adapted to permit the transmission of radiation there-through. Non-limiting examples of windows include automotive and aircraft transparencies, windshields, filters, shutters, and optical switches. As used herein the term “mirror” means a surface that specularly reflects a large fraction of incident light. As used herein the term “liquid crystal cell” refers to a structure containing a liquid crystal material that is capable of being ordered. One non-limiting example of a liquid crystal cell element is a liquid crystal display.

Still further, however, the multi-layer materials of the present invention can be used in contexts where optically clear materials are not needed or desired. For example, the photochromic materials can be used as paint, wallpaper, tiles, appliances, tables, automotive industry (e.g., door panels, roof panels, seating surfaces, tires, rims, wheels, paint, etc.), outdoor surfaces (e.g., concrete, bridges, sport courts, flooring, building surfaces, roofs, windows, street signs, etc.), sporting events (e.g., color of playing surfaces, goal posts, helmets, uniforms, equipment, etc.), etc.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Materials and Methods

Photochromic Dyes:

The photochromic dyes that were obtained from Vivimed Labs Europe Ltd., under the trade name ReversacolTM. The specific dyes are identified below in Tables 8 and 9.

Extrusion Conditions:

Polyethylene was pre-blended with selected additives and photochromic dyes as noted below in Table 8. The pre-blended polyethylene powder was extruded by using a shift screw extruder under the conditions identified in Table 1.

TABLE 1
(Compounding conditions for polyethylene
and photochromic dye (additive))

| Extruder Type | | Coperion Twin |
|---|---|---|
| Barrel Size | mm | |
| Screw Design | None | Shift Screw |
| Die | mm | 2.3 |
| Zone 1 Temp | ° C. | 30 |
| Zone 2 Temp | ° C. | 50 |
| Zone 3 Temp | ° C. | 70 |
| Zone 4 Temp | ° C. | 100 |
| Zone 5 Temp | ° C. | 170 |
| Zone 6 Temp | ° C. | 170 |
| Zone 7 Temp | ° C. | 170 |
| Zone 8 Temp | ° C. | 170 |
| Zone 9 Temp | ° C. | 170 |
| Zone 10 Temp | ° C. | 170 |
| Zone 11 Temp | ° C. | 170 |
| Zone 12 Temp | ° C. | 170 |
| Screw Speed | rpm | 300 |
| Throughput | kg/hr | 18 |
| Torque | % | 40 |
| Vacuum 1 | MPa | −0.08 |
| Side Feeder 1 Speed | rpm | 0 |

Similarly, polycarbonate (and its copolymers/blends) was pre-blended with other additives and photochromic dye. Then the pre-blended polycarbonate powder was extruded by using a shift screw extruder. The compounding conditions are provided in Table 2.

TABLE 2
(Compounding conditions for polycarbonate
and photochromic dye (additive))

| Extruder Type | | TEM-37BS |
|---|---|---|
| Barrel Size | mm | 1000 |
| Screw Design | None | S-1 |
| Die | mm | 3 |
| Zone 1 Temp | ° C. | 50 |
| Zone 2 Temp | ° C. | 100 |
| Zone 3 Temp | ° C. | 120 |
| Zone 4 Temp | ° C. | 200 |
| Zone 5 Temp | ° C. | 230 |
| Zone 6 Temp | ° C. | 230 |
| Zone 7 Temp | ° C. | 230 |
| Zone 8 Temp | ° C. | 230 |
| Zone 9 Temp | ° C. | 230 |
| Zone 10 Temp | ° C. | 230 |
| Die Temp | ° C. | 170 |
| Screw Speed | rpm | 300 |
| Throughput | kg/hr | 40 |
| Torque | % | 65 |
| Vacuum 1 | MPa | −0.08 |
| Side Feeder 1 Speed | rpm | 250 |

PC-PE Films:

A film laminator from Oasys Technologies Ltd. (Model—OLA6H; 240 Vac, 30 Hz, 2.5 KVA) was utilized for fusing or laminating the polycarbonate (or copolymers/blends) film with the polyethylene (or PP/PE, etc.) film. The polycarbonate (or copolymer/blends) films were made using the conditions in Table 3. The conditions to make the polyethylene film are listed in Table 4. The lamination conditions for fusing/laminating the two films together are listed Table 5. The formulation/composition of the polymeric films viz. HDPE & polycarbonate based have been listed in Table 8 & 9.

TABLE 3
(Conditions for polycarbonate (copolymers/blends) film)

| Step | Temp (° C.) | Press (psi) | Time (sec) |
|---|---|---|---|
| 1 | 205 | 50 | 1 |
| 2 | 185 | 100 | 240 |
| 3 | 185 | 100 | 1 |
| 4 | 185 | 100 | 1 |
| 5 | 185 | 100-200 | — |

TABLE 4
(Conditions for polyethylene film)

| Step | Temp (° C.) | Press (psi) | Time (sec) |
|---|---|---|---|
| 1 | 150 | 50 | 1 |
| 2 | 150 | 100 | 120 |
| 3 | 150 | 100 | 1 |
| 4 | 150 | 100 | 1 |
| 5 | 150 | 100-200 | — |

TABLE 5
(Laminating conditions for polycarbonate (copolymers/blends)
and polyethylene fused film)

| Step | Temp (° C.) | Press (psi) | Time (sec) |
|---|---|---|---|
| 1 | 205 | 50 | 1 |
| 2 | 185 | 200 | 240 |
| 3 | 185 | 100 | 1 |
| 4 | 185 | 200 | 1 |
| 5 | 185 | 200 | — |

Solvent Cast Films:

Solvent cast films were prepared by dissolving the polymer in toluene until a clear polymer/toluene solution was obtained. The solution was poured into a flat surface and allowed to evaporate slowly under ambient conditions overnight (about 10 hours) to obtain a clear film. Solvent cast films with dye were prepared in a similar manner with the dye being added to the polymer/toluene solution. The formulation/composition of the polymeric films are listed in Table 10.

PE Films:

A Fritsch, Pulverisetter 14 (Germany) was utilized for cryo-grinding polyethylene with dye to a powder. The powder was then made into a film using an Oasys Technologies, OLA6H laminator under isothermal conditions of 150° C., under a pressure ramp from 50 to 150 psi for a time period of 2 minutes. The formulations/compositions of the polyethylene and dyes are listed in Table 11.

Lamination of Bi-Layer Films.

A PC film (HFD 8089) without dye was made using the conditions listed in Table 3. COC films with and without dye (formulations #11 and #16 in Table 10, respectively) were made using the solvent cast method described above. An LDPE film with photochromic dye formulation (#17 in Table 11) was made into a film using the Oasys Technologies OLA6H laminator. The Oasys Technologies, OLA6H laminator was utilized to fuse or laminate the films together under isothermal conditions of 150° C., under a pressure ramp from 50 to 150 psi for a time period of 3 minutes. The films, composition of the films and the laminate properties are listed in Table 6.

TABLE 6

| | | Composition of | |
|---|---|---|---|
| # | Films* | Laminate Layers | Laminate Property |
| 20 | PC/COC | HFD 8089 and COC-16 | Clear, colorless |
| | | (storm purple) | |
| 21 | COC/LDPE | COC-11; LDPE-17 | Clear, colorless |
| | | (storm purple) | |

*PC and HFD is polycarbonate; COC is cyclic olefin copolymer, and LDPE is low density polyethlene.

Lamination of Tri-Layer Films.

The Oasys Technologies, OLA6H laminator was utilized to make tri-layer laminates from COC film with dye (#12 (photochromic), #13 (non-photochromic), and #14 (non-photochromic), Table 10), PE (LDPE) film with photochromic dye (#17, Table 11), PE (HDPE) film with photochromic sea green dye (#18, Table 11) and polycarbonate (HFD) film with non-photochromic dyes (#15-16, Table 10) films under isothermal conditions of 165° C., under a pressure ramp from 50 to 150 psi for a time period of 4 minutes. The composition of the films and the laminate properties are listed in Table 7. The original color of the laminates was red.

TABLE 7
(Tri-layer laminates)

| | PC Films | PE Film | COC Film | | |
|---|---|---|---|---|---|
| | Compo- | Compo- | Compo- | | |
| | sition | sition | sition | | Laminate |
| # | (Table 10) | (Table 11) | (Table 10) | Film Order* | Property |
| 22 | #15; #16 | — | #12 | PC-15/ | Clear, |
| | | | | COC-12/PC-16 | Red Color |
| 23 | — | #17 | #13; #14 | COC-13/ | Partially |
| | | | | LDPE-17/COC-14 | Opaque, |
| | | | | | Red Color |
| 24 | #15; #16 | #18 | — | PC-15/ | Partially |
| | | | | HDPE-18/PC-16 | Opaque, |
| | | | | | Red Color |

*PC is polycarbonate; COC is cyclic olefin copolymer, LDPE is low density polyethylene, and HDPE is high density polyethylene.

Testing Materials and Protocols:

An Atlas Suntest CPS with 1×1500 W air-cooled xenon lamp, 560 cm² exposure area, with direct setting and control of irradiance in the wavelength range of 300-800 nm/Lux; or 300-400 nm/340 nm was used. A Gregtage Macbeth Color-eye 7000A X-rite Spectrometer for L,a,b measurements over a time scale was used.

Samples were exposed to Suntester for 30 to 60 seconds. The spectral data was recorded immediately. Light absorbances values along with light percent transmittance, % T, were measured. The data was recorded over a span of 2-3 minutes with 10 second intervals. Reference value is light transmittance of an unexposed sample.

TABLE 8
(Formulation/composition of polyethylene (HDPE-
B5823*) and Sea Green (Vivimed dyes))

| | | Amount | Photochromic | Amount | Amount |
|---|---|---|---|---|---|
| # | Polymer | (Kg) | Dye | (ppm) | (g) |
| 1 | HDPE | 1 | Sea green | 1500 | 1.5 |
| 2 | HDPE | 1 | Sea green | 500 | 0.5 |
| 3 | HDPE | 1 | Sea green | 250 | 0.25 |
| 4 | HDPE | 1 | Sea green | 125 | 0.125 |
| 5 | HDPE | 1 | Sea green | 75 | 0.075 |
| 6 | HDPE | 1 | 2039 (Slow fading) | 75 | 0.075 |

*High density polyethylene (HDPE).

TABLE 9
(Formulation/composition of polycarbonate
(HFD-8089*), LDPE** with Vivimed dyes)

| | | Amount | Photochromic | Amount | Amount |
|---|---|---|---|---|---|
| # | Polymer | (Kg) | Dye | (ppm) | (g) |
| 1 | HFD | 1 | Sea green | 500 | 0.5 |
| | 8089 | | | | |
| 2 | HFD | 1 | Sea green | 250 | 0.25 |
| | 8089 | | | | |
| 3 | HFD | 1 | Sea green | 75 | 0.075 |
| | 8089 | | | | |
| 4 | HFD | 1 | Storm purple | 500 | 0.5 |
| | 8089 | | | | |
| 5 | HFD | 1 | Storm purple | 75 | 0.075 |
| | 8089 | | | | |
| 6 | HFD | 1 | 2039 (slow fading) | 500 | 0.5 |
| | 8089 | | | | |
| 7 | HFD | 1 | 2197 (slow fading) | 500 | 0.5 |
| | 8089 | | | | |
| 8 | HFD | 1 | Sea green + | 500 + 10 g | 0.5 |
| | 8089 | | Irganox 1098 | | |
| 9 | LDPE | 1 | Storm purple | 800 | 0.8 |
| 10 | LDPE | 0.8 | Aqua green | 500 | 0.5 |

*HFD is a bisphenol-A polycarbonate, sebacic acid copolymer and provides for relatively more void space in the matrix for the photochromic dyes to switch or change their respective chemical structures in response to light or heat. The processing temperature is lower than bisphenol-A polycarbonate and thus, the photochromic dye does not undergo any thermal degradation.
**Low Density Polyethylene (LDPE).

TABLE 10
(Formulation/composition of polycarbonate
and COC films and dyes)

| | | Amount | | Amount | Solvent |
|---|---|---|---|---|---|
| # | Polymer | (mg) | Dye | (mg) | (10 mL) |
| 11 | COC* | 500 | | | Toluene |
| 12 | COC | 500 | Storm Purple | 0.2 | Toluene |
| 13 | COC | 500 | **CAS 343232-69-9 | 20 | Toluene |
| 14 | COC | 500 | **CAS 1210881-03-0 | 2 | Toluene |
| 15 | HFD | 500 | **CAS 343232-69-9 | 20 | Dichloro- |
| | 8089 | | | | methane |
| 16 | HFD | 500 | **CAS 1210881-03-0 | 2 | Dichloro- |
| | 8089 | | | | methane |

*Cyclic olefin copolymer, TOPAS 5013 (Topas Advanced Polymers, Germany).
**Non-photochromic dyes

TABLE 11
(Formulation/composition of LDPE and
HDPE Films with Photochromic dyes)

| | | Amount | Photochromic | Amount | Amount |
|---|---|---|---|---|---|
| # | Polymer | (Kg) | Dye | (ppm) | (g) |
| 17 | LDPE | 1 | Storm purple | 800 | 0.8 |
| 18 | HDPE | 1 | Sea Green | 75 | 0.075 |

### Example 2

### Results

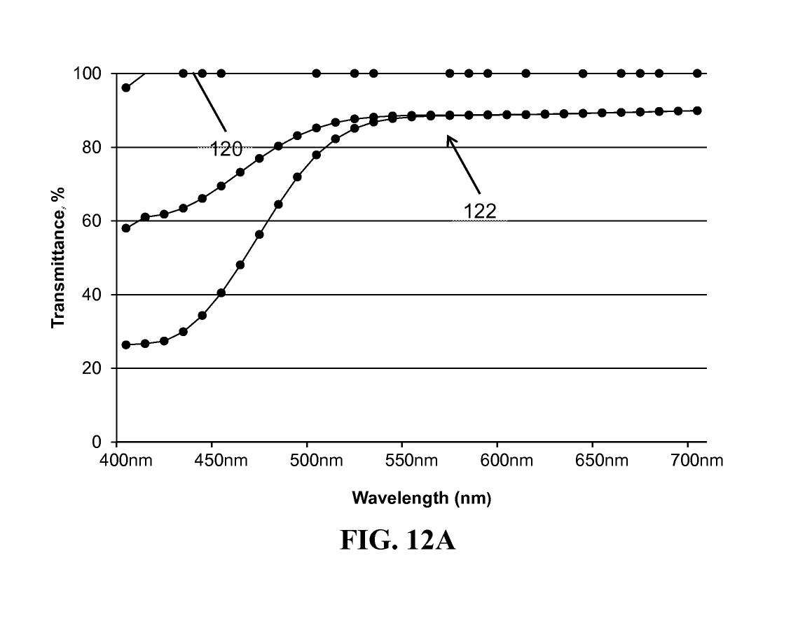

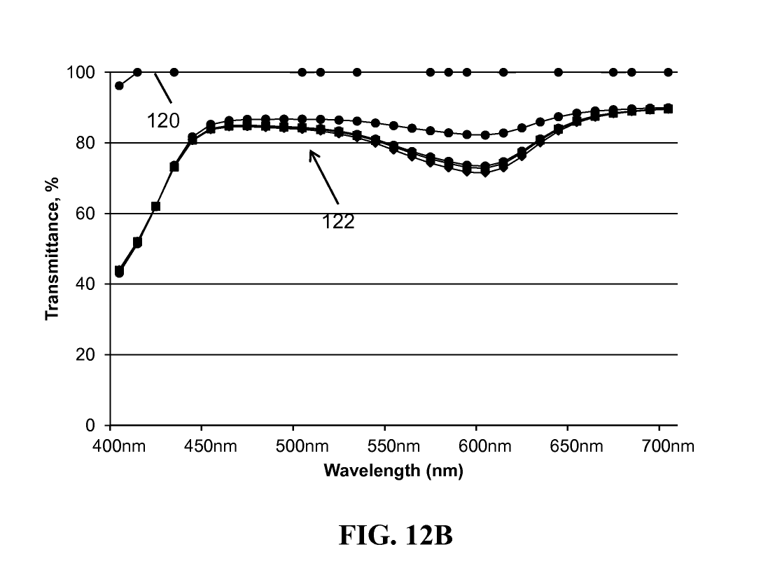

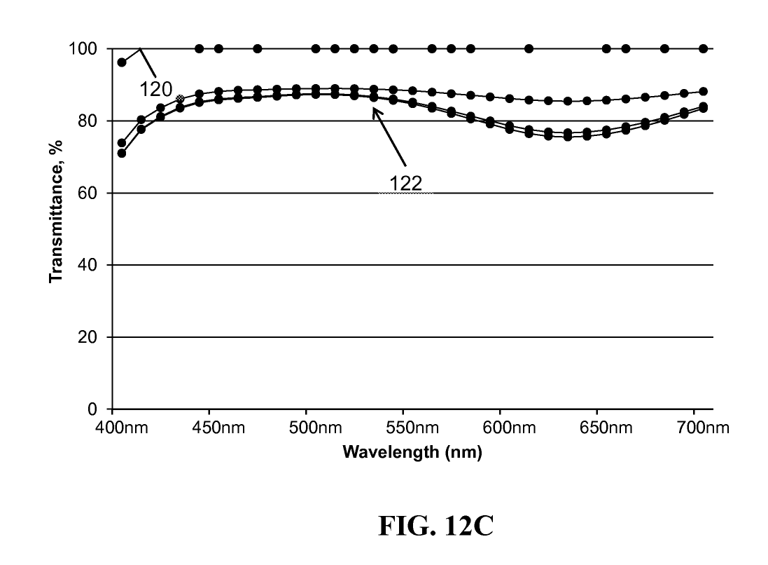

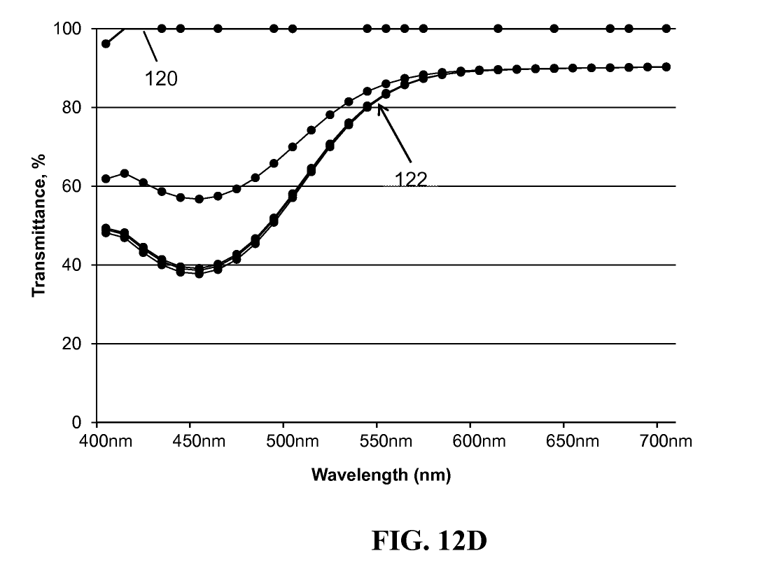

Polycarbonate with Vivimed photochromic dyes. The processed samples of polycarbonate (HFD) with various Vivimed photochromic dyes (Table 7) were irradiated with UV to study the photochromic performance of the HFD part (FIGS. 12A-D). FIG. 12A is a graph of wavelength in nanometers versus percent transmittance of a material of the present invention that includes a high flow ductile (HFD) polycarbonate polymer and 500 ppm of dye-2197. FIG. 12B is a graph of wavelength in nanometers versus percent transmittance of a material of the present invention that includes a HFD polycarbonate polymer and 500 ppm of Storm Purple. FIG. 12C is a graph of wavelength in nanometers versus percent transmittance of a material of the present invention that includes a HFD polycarbonate polymer and 500 ppm of Sea Green. FIG. 12D is a graph of wavelength in nanometers versus percent transmittance of a material of the present invention that includes the HFD polycarbonate polymer and 500 ppm of dye 2039. In each figure data line 120 is the unexposed sample (100% transmittance) and is used as the reference. Data lines 122 are data recorded after exposure to the Suntester. In each of the samples, a good intensity of color developed in the HFD matrix with the photochromic dye.

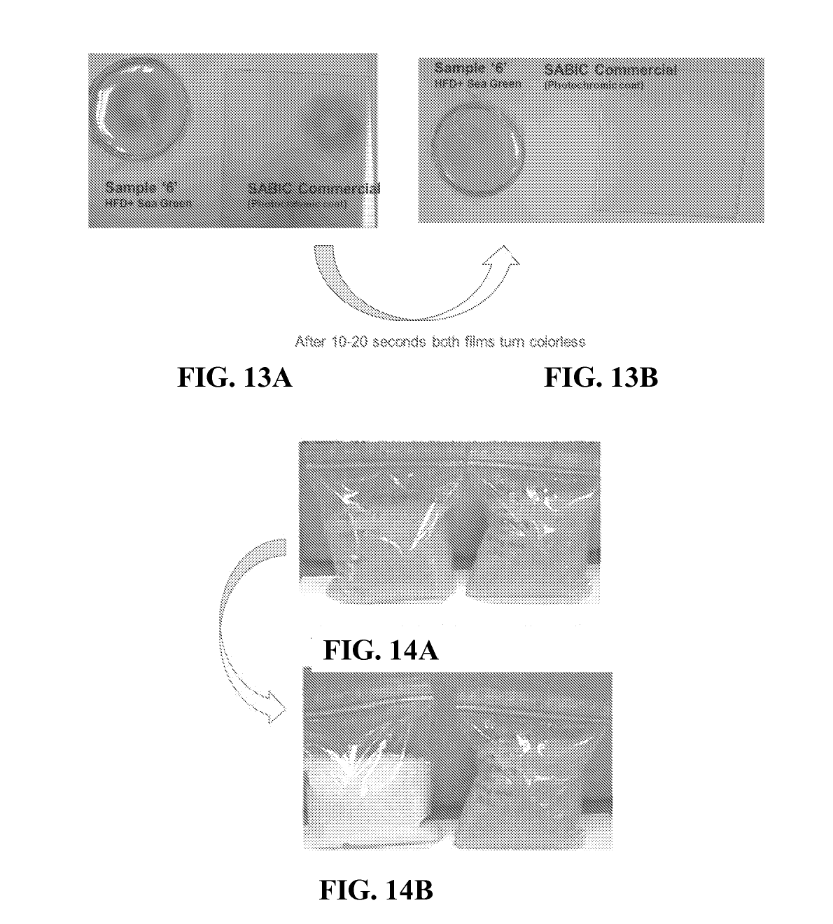

In addition to the good intensity of color, the HFD matrix with photochromic dye showed a fast fading of the dye color ranging between 15 and 60 seconds. FIG. 13A is an image of the HFD matrix of the present invention (right sample) and a commercial polyurethane coating (left sample) that has been exposed to light. FIG. 13B is the same samples after 10 to 20 seconds. As seen in FIG. 13B both samples turned colorless after about 10-20 seconds. The remnant color was very faint after about 60 seconds. Thus, the fading rate of the photochromic dye in HFD (solvent-cast film) was found to be comparable with the commercial polyurethane coatings.

Polyethylene with Dyes.

HDPE samples made with Sea Green (Table 8). Upon exposure to room light, some of the samples turned blue. These kinds of observations are due to the absorption pattern of the photochromic dye used. FIGS. 14A and B depict images of pellets of the HDPE matrix with Sea Green dye. FIG. 14A is an image of the bags before exposure to fluorescent light. FIG. 14B is an image of the bags after exposure to fluorescent light. As shown in FIG. 14B, pellets in three of the bags turned blue upon exposure to room light. Thus, it was realized that the choice of dyes would be based on the requirement for the respective application.

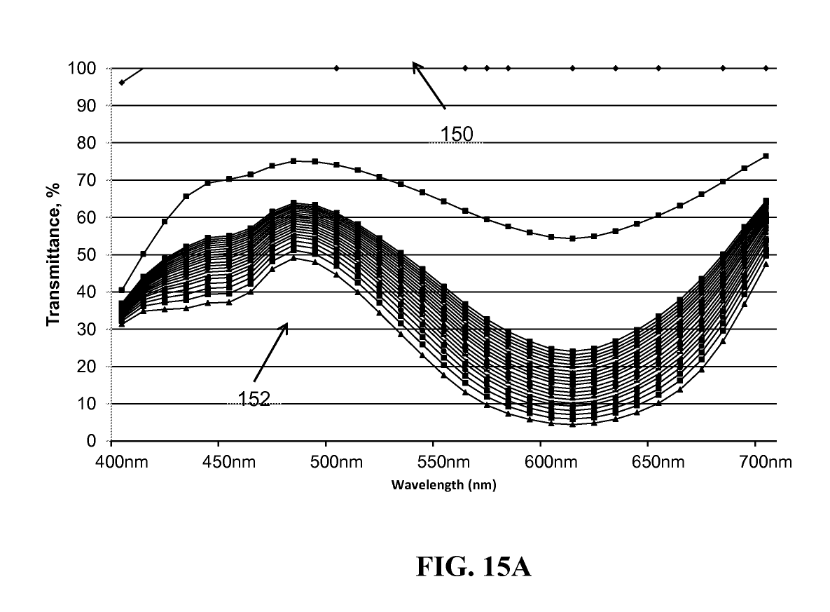

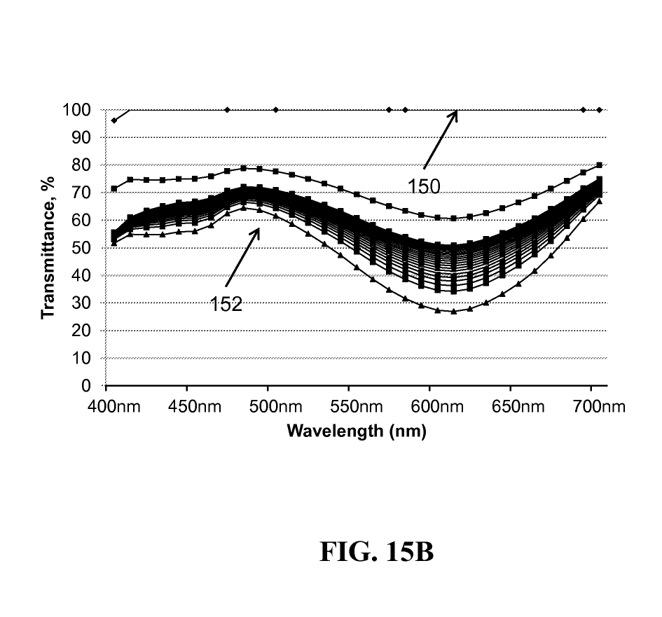

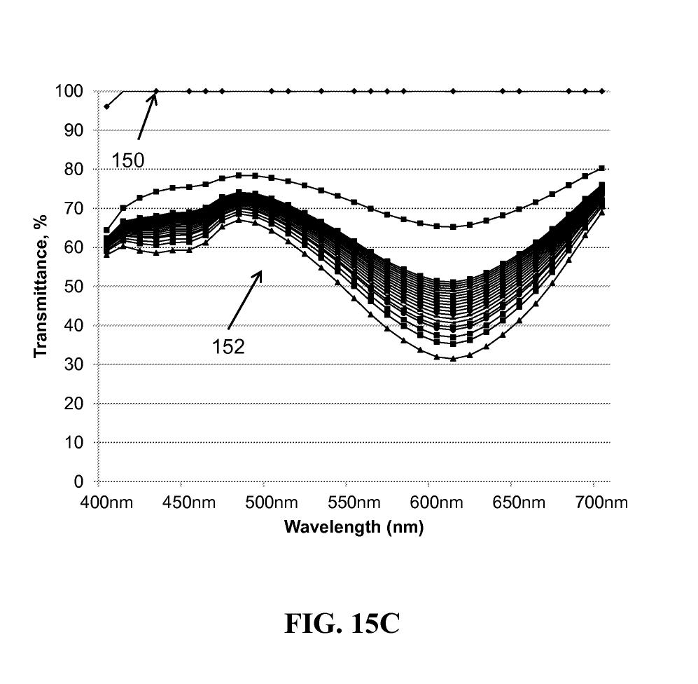

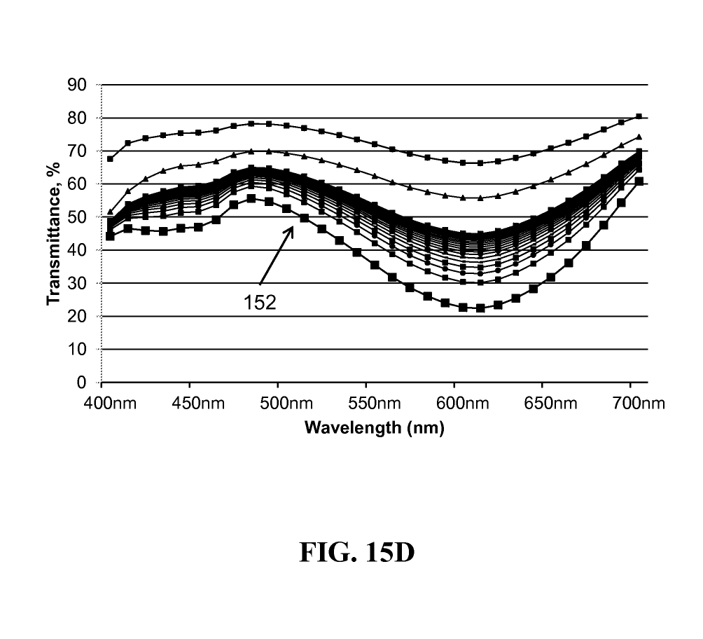

The various compositions of HDPE with Sea Green (Table 8) were studied for the effect of dye concentration on color intensity on UV exposure. FIG. 15A is a graph of wavelength in nanometers versus percent transmittance of a material of the present invention that includes a HDPE polymer and 1500 ppm of Sea Green dye. FIG. 15B is a graph of wavelength in nanometers versus percent transmittance of a material of the present invention that includes a HDPE polymer and 500 ppm of Sea Green dye. FIG. 15C is a graph of wavelength in nanometers versus percent transmittance of a material of the present invention that includes a HDPE polymer and 250 ppm of Sea Green dye. FIG. 15D is a graph of wavelength in nanometers versus percent transmittance of a material of the present invention that includes a HDPE polymer and 125 ppm of Sea Green dye. It was realized that with higher concentration of the dye, the color intensified. In each figure data line 150 is the unexposed sample (100% transmittance) and is used as the reference. Data lines 152 are data recorded after exposure to the Suntester. In each of the samples, a good intensity of color developed in the HDPE matrix with the photochromic dye. As shown in FIGS. 15A-15D, the amount of transmittance can be changed based on the amount of dye present in the polymer matrix.

Comparative Materials and Materials of the Present Invention.

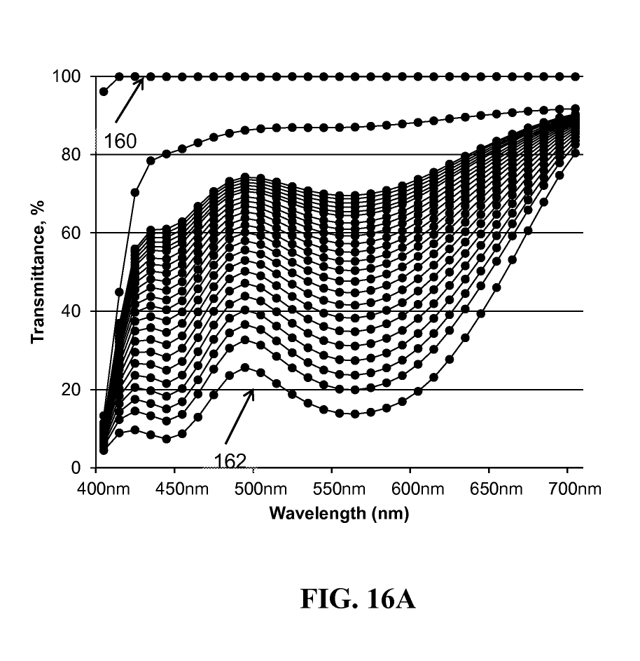

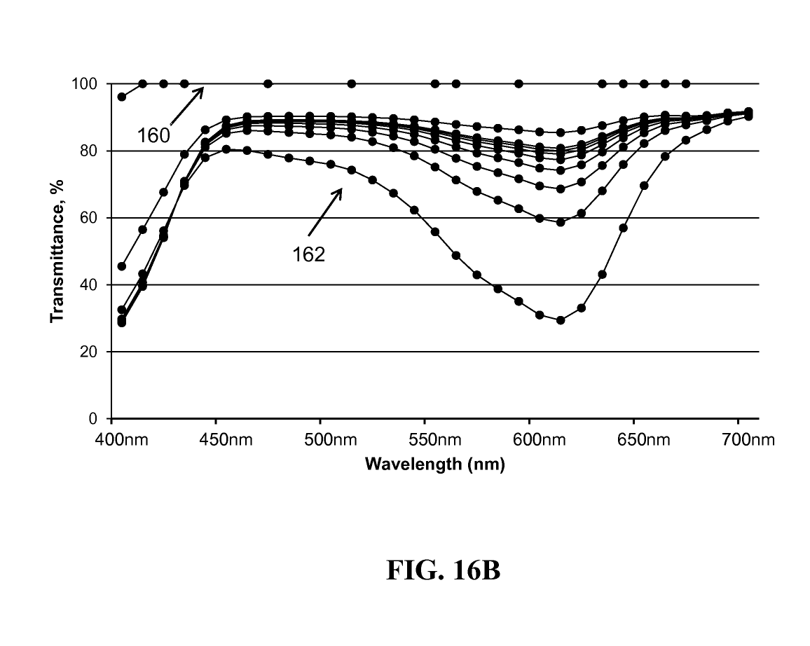

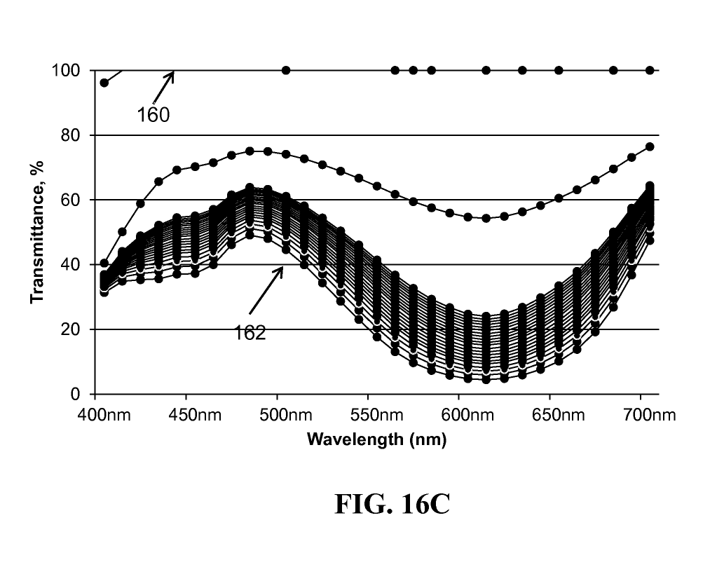

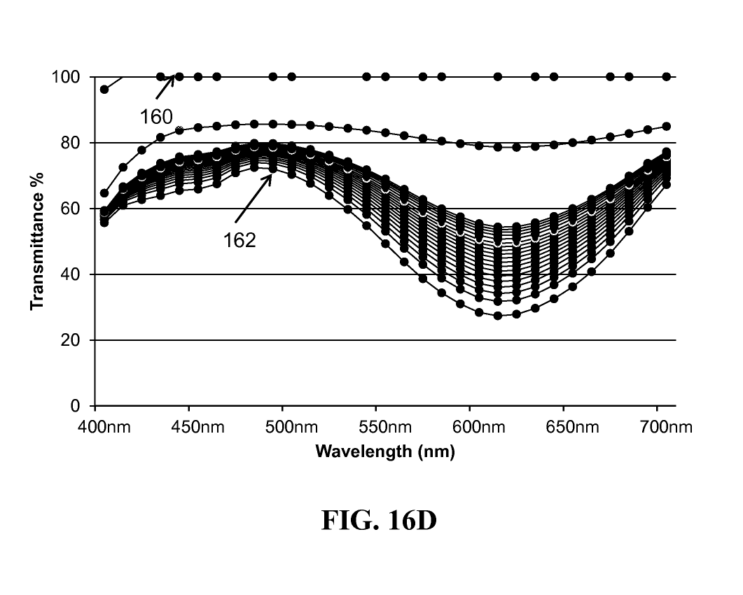

The transmittance of visible light in colorless and colored states was measured for a commercial product (FIG. 16A), an experimental grade coating (FIG. 16B) and samples of films of the present invention (FIGS. 16C and 16D). FIG. 16C is a sample of HDPE and Sea Green dye (Table 8, #1) laminate. FIG. 16D is a sample of HFD-HDPE (Sea green, 1500 ppm) laminate. In each figure data line 160 is the unexposed sample (100% transmittance) and is used as the reference. Data lines 162 are data recorded after exposure to the Suntester. By comparison, samples of HDPE with Sea Green dye (FIG. 16C) and HFD-HDPE Laminate with Sea Green dye (FIG. 16D) showed fading speed of dye comparable to the comparative samples (FIGS. 16A and 16B). This confirms that optically clear polycarbonate-based lenses (thermoplastic) can be prepared via a one-step extrusion method which reduces the complexity of currently existing methods of making photochromic lenses (e.g., coatings, surface impregnations, etc.).

Color Changing Laminates.

Samples with photochromic dyes, non-photochromic dyes and both were irradiated with room light and ultra violet light and the change in color was determined. Initially all the trilaminates (as listed in Table 7) are red in color due to red non-photochromic dyes; UV light was produced with UV torch model LABINO UV-375 with a peak wavelength of 375 nm

Red laminate #22 (HFD-15/COC-12/HFD-16), has the COC film with the photochromic storm purple dye (COC-12) between the permanently colored HFD film layers (Films #15-16). The laminate #22 was positioned with film HFD-16 (perylene dye) facing towards the light, and was irradiated with room light. No color change was observed. Upon irradiation of the red Laminate #22 with UV light, the color of the laminate turned from red to greyish blue. The color change was due to the COC-photochromic dye film between the two polycarbonate films.

Red Laminate #23 (COC-13/LDPE-17/COC-14) has the LDPE film with the photochromic storm purple dye (LDPE-17) between the COC films with non-photochromic dye (COC-13 and COC-14). The laminate was positioned so that the perylene based COC film layer (COC-14) faced towards the light. Irradiation with room light produced no color change (i.e., the laminate remained red). Upon irradiation with UV light the color of the laminate turned from red to greyish blue. The color change was due to the LDPE-17-photochromic dye film between the two cyclic-olefin films.

Laminate #24 (HFD-15/HDPE-18/HFD-16) has the HDPE film with the sea green photochromic dye (HDPE-18) between two polycarbonate films with non-photochromic dyes (HFD-15 and HFD-16). The laminate was positioned so that the perylene based PC film layer (HFD-16) faced towards the light. Upon irradiation with room fluorescent light no color change was observed (i.e., the laminate remained red). Upon irradiation with UV light, the color of the laminate turned from red to ocean blue. The color change was due to the HDFE-18 photochromic dye film between the two polycarbonate films (HFD-15 and HFD-16).

1. A photochromic material comprising a first polymeric layer comprising a photochromic compound that is capable of being activated in response to a stimulus, wherein the first polymeric layer is configured such that the activated photochromic compound becomes inactivated within 10 minutes in the absence of said stimulus.

2. The photochromic material of claim 1, wherein the first polymeric layer comprises a polyolefin polymer or co-polymer thereof or a polyurethane polymer or co-polymer thereof, or blends thereof.

3. The photochromic material of claim 2, wherein the polyolefin polymer or co-polymer thereof is polyethylene or polypropylene.

4. (canceled)

5. (canceled)

6. The photochromic material of claim 1, wherein the photochromic compound in the first polymeric layer is a chromene, a spiroxazine, a spiropyran, a fulgide, a fulgimide, an anil, a perimidinespirocyclohexadienones, a stilbene, a thioindigoid, an azo dye, or a diarylethene, or any combination thereof.

7. The photochromic material of claim 1, wherein the first polymeric layer is configured to have a first color when the photochromic compound is in its inactive form and a second color when the photochromic compound is in its active form, wherein the first and second colors are different.

8. The photochromic material of claim 7, wherein the first color and second colors are each optically clear, red, orange, yellow, green, blue, violet, white, black, or any shade or variation or combination thereof.

9. The photochromic material of claim 8, wherein the first color is optically clear.

10. The photochromic material of claim 1, wherein the stimulus is electromagnetic radiation.

11. The photochromic material of claim 10, wherein the electromagnetic radiation is ultraviolet light or visible light.

12. The photochromic material of claim 1, wherein the photochromic material is in contact with or adhered to a substrate.

13. The photochromic material of claim 12, wherein the substrate is a second polymeric layer.

14. The photochromic material of claim 11, wherein the second polymeric layer comprises a polycarbonate polymer or copolymer thereof, a polysulphone polymer or co-polymer thereof, a cyclo olefin polymer or co-polymer thereof, a thermoplastic polyurethane polymer or co-polymer thereof, a thermoplastic polyolefin polymer or co-polymer thereof, a polystyrene polymer or co-polymer thereof, a poly(methyl)methacrylate polymer or co-polymer thereof, or any blends thereof.

15. The photochromic material of claim 14, wherein the second polymeric layer comprises a polycarbonate polymer or co-polymer thereof.

16. The photochromic material of claim 15, wherein the second polymeric layer comprises a polymeric blend comprising said polycarbonate polymer and a polyester polymer.

17. The photochromic material of claim 16, wherein the second polymeric layer comprises a bisphenol A-sebacic acid co-polymer.

18. The photochromic material of claim 11, wherein the second polymeric layer does not include a photochromic compound.

19. The photochromic material of claim 11, wherein the second polymeric layer comprises a second photochromic compound selected from a chromene, a spiroxazine, a spiropyran, a fulgide, a fulgimide, an anil, a perimidinespirocyclohexadienones, a stilbene, a thioindigoid, an azo dye, or a diarylethene, or any combination thereof.

20. The photochromic material of claim 11, wherein the second polymeric layer comprises a non-photochromic dye, an irreversible photochromic compound, or pigment.

21-24. (canceled)

25. A photochromic material comprising:
(i) a first polymeric layer comprising a first photochromic compound that is capable of being activated in response to a first stimulus, wherein the first polymeric layer is configured to change from color 1 to color 2 upon exposure to the first stimulus and back to color 1 upon removal of the first stimulus, wherein color 1 and color 2 are different; and
(ii) a second polymeric layer comprising one or more additional compounds, wherein at least one of the additional compounds is a second photochromic compound, a thermochromic compound, an electrochromic compound, a permanent dye, pigment, an irreversible photochromic compound, or any combination thereof,
wherein the first polymeric layer is coupled to the second polymeric layer.

26-57. (canceled)

58. An article of manufacture or surface comprising the photochromic material of claim 1, wherein the article of manufacture or surface is paint, wallpaper, floor or roof tile, an appliance, a table, an automotive part, an outdoor surface, a sporting equipment, or eyewear.

59. (canceled)
